(19) United States
(12) Patent Application Publication
(10) Pub. No.: US 2004/0237931 A1
(43) Pub. Date: Dec. 2, 2004

(54) Mixture supply device for internal-combustion engine

(76) Inventors: Yoshio Okamoto, Minori (JP); Tomonaga Oyamada, Minamiarupusu (JP); Makoto Yamakado, Tsuchiura (JP); Teruhiko Minegishi, Hitachinaka (JP); Akihiro Munakata, Hitachinaka (JP); Yuzo Kadomukai, Ishioka (JP); Masami Nagano, Hitachinaka (JP); Takehiko Kowatari, Kashiwa (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/796,031

(22) Filed: Mar. 10, 2004

(30) Foreign Application Priority Data
Mar. 10, 2003 (JP) 2003-062694
Feb. 19, 2004 (JP) 2004-042198
Feb. 19, 2004 (JP) 2004-042199

(51) Int. Cl. F02B 31/00

(52) U.S. Cl. 123/308; 123/336

(57) ABSTRACT

To maintain a favorable combustion states, the quantity and quality of a fuel-air mixture to be supplied to cylinders in an internal-combustion engine having multi-cylinder combustors, is where motor-driven fuel spraying mechanisms are provided corresponding to respective cylinders, is controlled with a high response. For this purpose, a mixture supply device has a motor-driven exhaust recirculating mechanism for collecting part of the exhaust generated by combustion in the internal-combustion engine and then remixing the exhaust into the mixture, and an integrated controller for transmitting control signals simultaneously to the above-mentioned three types of mechanisms which are built into a motor-driven multiple-throttle mechanism. The motor-driven multiple-throttle mechanism operates to control a plurality of air inlet passageways with one motor, being formed with restrictions of different sizes and shapes in respective inlet passageways, even at the same rotational angle, and being equipped with an air flow control valve capable of accelerating air flow.

### BACKGROUND OF THE INVENTION

The present invention relates to a mixture supply device for use in an automobile internal-combustion engine; and, more particularly, the invention relates to a mixture supply device that is equipped with a mechanism for improving the combustion state within the engine and for reducing harmful exhaust gas emission levels.

In order to protect the global environment, automobile engines are required to have reduced emission levels of harmful exhaust gases which create air pollutants represented by the substances included in the exhaust gases, such as unburnt fuel, carbon monoxide, hydrocarbon, and nitrogen oxides, and, for purposes of energy conservation, they are required to exhibit reduced fuel consumption. To respond to these requirements, it is desirable to achieve a better combustion state at all times in a wide range of engine operating conditions and engine speeds by forming a higher-quality mixture and supplying it to the cylinder interior that operates as a combustion chamber.

To improve the combustion state, it is required that a highly combustible mixture be formed by appropriately mixing air and recirculated exhaust, and that fluidity be given to this mixture to create a state under which combustion easily propagates inside the cylinder. It is possible, by rapidly changing the state of such a mixture to an appropriate state according to the output command issued by the accelerator (i.e. throttle pedal) operations of the driver, and by incorporating that state into the control of the engine output, to stabilize the combustion state under both a steady operating state of the engine and the transient operating state thereof, thereby to contribute to a reduction of harmful exhaust gas emission levels and a reduction in fuel consumption. A mixture supply device which performs these functions is required to have reduced dimensions and a low price so as to be mountable in a general automobile, so that a more significant global environmental protection effect can be obtained by mounting such a device in a larger number of automobiles.

The structures, called modules or units, that are integrated by combining a plurality of functions and devices, such as a fuel supply device and a throttle device, for controlling the quantity of air taken in, are used primarily for minimizing the dimensions and reducing engine manufacturing costs by simplifying assembly operations. Examples of such conventional module structures include a multiple-throttle body for controlling the flow rate of the air taken into the cylinders, inclusive of air inlet passageways and throttle valves, of the engine, a fuel injection device, a fuel pump, a fuel filter, a fuel pressure regulator type of fuel injection device for automotive motorcycles, and the like. (See, for example, Patent reference 1: Japanese Application Patent Laid-Open Publication No. Hei 10-122101). Also, an injector for supplying fuel, a fuel pump, a fuel filter, a fuel pressure regulator, and an electronic control device are assembled with a throttle device to form a unit (see, for example, Patent reference 2: Japanese Application Patent Laid-Open Publication No. 2001-263128). In these conventional structures, the devices required for the construction of an air inlet system on the engine are integrated. Compared with the independent mounting of each device, by integrating all necessary devices, it is possible to improve their productivity and their mountability on the engine and save engine manufacturing costs, and also to compensate for any changes in the quantity of fuel injection for each unit according to the particular characteristics of the throttle and of the injector, thereby to reduce the performance variations occurring during mounting of the assembly on the engine.

### SUMMARY OF THE INVENTION

<Problems to be Solved by the Invention>

In such modules and units, however, even when the quantity of air taken into the cylinder and the quantity of fuel injection are controlled by the throttle device and the fuel injection device, respectively, the controllability of the air flow is insufficient, which makes it difficult to achieve an improvement in the fuel injection, such as improving the fuel-atomizing characteristics using the flow of air or of the recirculated exhaust gases, and to generate and control a swirl flow, and the like, in the mixture. Accordingly, compared with the construction not having devices integrated into a unit, a module or unit construction has experienced difficulties in obtaining a significant combustion state improvement effect. During low-speed operation of a general engine, in particular, since the quantity of air taken in by the engine within a fixed time is small, and, thus, the velocity and flow rate of the air introduced into the engine are low, the activation of air flow, the atomization of the fuel, the spatial distribution control of the fuel droplet size, and other active measures for accelerating combustion are required for achieving reduced harmful exhaust gas emission levels. For these reasons, in conventional engine control systems, it has been necessary to provide certain measures, such as, in addition to installing the above-mentioned throttle device, separately installing an air flow control valve, called a swirl control valve or a tumble control valve, that is intended to accelerate the air flow. Also, to supply recirculated exhaust gas (EGR: Exhaust Gas Recirculation), which is considered to be necessary for reducing nitrogen oxides, since it is necessary to install a special introduction port and a special control device at remote independent locations, and since the installation locations themselves differ according to the engine, the control timing and dynamic characteristics have needed to be modified according to the particular construction of the engine.

The present invention was made with the above-described problems in view, and an object of the invention is to provide a mixture supply device that can improve the combustion state within an engine and reduce harmful exhaust gas emission levels by rapidly and appropriately controlling the air, fuel, and recirculated-exhaust quantities in the mixture supplied to the engine cylinders, as well as to control the sprayed fuel state, the mixture state, and the flow state, according to the particular accelerator operations of the driver and the particular operating conditions of the engine.

Another object of the invention is to provide a mixture supply device that can reduce the quantities of harmful exhaust gases emitted during cold starting of an engine when the atomization of its fuel is insufficient, or when the fuel, even if fully atomized, heavily sticks to the inner wall of an air inlet pipe, or when the quantity of fuel to be supplied is increased to compensate for it's a shortage of fuel due to fuel sticking to the inner wall of the air inlet pipe.

<Means for Solving the Problems>

The mixture supply device according to the present invention comprises a multiple throttle mechanism into which a fuel spraying mechanism, an exhaust recirculating mechanism, and an integrated controller are integrally formed. The multiple throttle mechanism, in particular, has a built-in air flow control valve that makes it possible not only to form one or more restrictions for each cylinder of the engine and to control the flow rate of air by changing the size of the restrictions formed in a plurality of inlet passageways, but also, at the same time, to form restrictions having different shapes for each inlet passageway, thereby to control the swirl and deflecting air streams in the inlet passageways and in the cylinders. This air flow control valve also controls the flow of a mixture in the inlet passageways and the cylinders by generating different flow rates and velocities for each inlet passageway, and when air flows through the valve, for deflecting the traveling direction of the air flow taken in. Thus, it becomes possible to obtain an effect equivalent to that achievable in the conventional structures having, in addition to a throttle device, a valve device for controlling the flow of air. In addition, this air flow control valve accelerates the swirl flow of air that occurs at a low flow rate, and it also accelerates combustion more efficiently by concentratedly supplying an air stream in its deflected condition towards the vicinity of the fuel spraying mechanism, thereby improving the atomization characteristics of the fuel by the action of collision between the fuel droplets and the high-speed air stream. For application to an engine having a plurality of inlet routes for one cylinder, the air velocity is increased by passing a larger quantity of air through a specific inlet route at low flow rate, and the quantity of air taken into the cylinder per cycle is increased by increasing the inertial force of the air. Consequently, the engine output obtained at the same engine speed can be increased, which, in turn, contributes to reduced fuel consumption.

Furthermore, the air flow control valve in the multiple-throttle mechanism can simultaneously control the flow rates of air and its flow in a plurality of inlet passageways, and it has a sealed structure that reduces the leakage of the air which continuously flows between adjacent inlet passageways and through the upstream and downstream regions of the valve. For an increased sealing effect, a guide groove machined in the valve is provided with a movable sealing member which is movable in the guide groove, and the clearances of the flow passageways are reduced or sealed by controlling the movement of the movable sealing member according to certain factors, such as electromagnetic force and the pressure difference occurring between the upstream and downstream sides of the valve when its opening state is not too significant. Contact between the movable sealing member and its mating surface under the sealed state of the flow passageways significantly occurs in part of the valve rotation range, such as in the case of a fully closed or slightly opened state, under which particularly high sealing performance is required, and this thereby enhances the contact sealing effect. In most of the valve rotation range, however, no contact occurs or there is only very slight contact. Thus, it becomes possible to accurately control the flow rates down to a low flow rate, while at the same time suppressing increases in the torque required for rotational driving of the valve. The adoption of such a sealed structure improves the controllability of the air flow in the air flow control valve, the controllability of the flow rates, and the air velocity increasing effect, and contributes to further improved combustion and reduced fuel consumption.

This mixture supply device is installed halfway on an air inlet route leading to the cylinder interior in an automobile engine; more particularly, it is installed downstream from its surge tank at which the air inlet pipe routed from an air cleaner is diverged towards each cylinder, halfway on an independent air inlet pipe directly connecting the surge tank and each cylinder. Consequently, air, fuel and recirculated exhaust are all controlled at a position close to the cylinder, so that the responsiveness of mixture formation improves, and variations in response between the three fluids are reduced. This mixture supply device is electrically connected to the accelerator (i.e. the throttle pedal), and the fuel spraying mechanism, the exhaust recirculating mechanism, and the multiple-throttle mechanism are driven by respective motors and controlled in accordance with the commands sent from the integrated controller. While considering the operating state of the accelerator, the operating conditions of the engine, and the state of exhaust, the integrated controller changes the engine output according to the particular accelerating/decelerating operations of the driver, and, in order to minimize harmful exhaust gas emissions and fuel consumption, it synthetically determines the fuel injection rate, the recirculated-exhaust mixing rate, the air supply rate, the flow of the air, and the like, in the corresponding mixing and forming device, and it transmits control commands to each mechanism.

In the inlet passageways communicating with the openings in the restrictions of the air flow control valve which constitutes the mixture supply device, the fuel spraying port of the fuel spraying mechanism is disposed downstream from the opening in each restriction, and, during the starting operation of the engine, a high-speed air stream created at each restriction in the air flow control valve is routed from the outer periphery of the fuel spraying mechanism to the fuel spraying port, so that the fuel particles being injected are further atomized and are then carried by the high-speed air stream.

The air flow control valve can, by its rotary motion, change the cross-sectional shape of the openings in the restrictions. During the air inlet stroke period of the internal-combustion engine, when the engine is started, the small area of the opening in each restriction in the air flow control valve is controlled to change to a large area. The air stream, after being speeded up at the restriction, is then inducted from the outer periphery of the fuel spraying mechanism into the fuel spraying port, and it further atomizes the fuel particles that are injected, thus extending the opening area of the restriction, and carrying the fuel particles by means of the quantitatively increased air stream.

Furthermore, the openings in the above-mentioned air flow control valve have a convex shape, and, during the rotary motion of the valve, the openings with a small area are located close to the fuel spraying port of the fuel spraying mechanism, in the inlet passageways, and the openings with a large area are disposed so as to be remote from the fuel spraying port of the fuel spraying mechanism, in the inlet passageways. When the engine is started, control is provided so that the small opening area changes to a large opening area during the starting operation of the engine, with the consequence that, as described above, the fuel particles that are injected are further atomized and then carried by a quantitatively increased air stream.

By using such a mixture supply device, a mixture created by mixing air, fuel and recirculated exhaust, to obtain a moderate rate and moderate quality and fluidity, can be supplied in a high-response controlled condition, the formation of a favorable combustion state in each cylinder can be accelerated, and harmful exhaust and fuel consumption can be reduced.

### BRIEF DESCRIPTION OF THE DRAWINGS

FIG. 1 is a diagrammatic external view of a mixture supply device pertaining to the present invention, as applied to an in-line four-cylinder type of automobile engine having two inlets per cylinder;

FIG. 2 is a view of the mixture supply device as seen in the X-direction in FIG. 1;

FIG. 3 is a cross-sectional view taken along line A-A′ in FIG. 2;

FIG. 4 is a cross-sectional view taken along line B-B′ in FIG. 2;

FIG. 5 is a diagrammatic top plan view showing the configuration of the air inlet system used in a conventional general engine;

FIG. 6 is a block diagram showing the flow in the supply of a mixture to a cylinder in the air inlet system of the conventional general engine shown in FIG. 5;

FIG. 7 is a diagrammatic top plan view showing an air inlet system with the mixture supply device of the prevent invention as applied to the engine shown in FIG. 5;

FIG. 8 is a schematic diagram showing the flow in the supply of a mixture to a cylinder in the air inlet system of the engine to which the mixture supply device of the prevent invention, shown in FIG. 7, is applied;

FIG. 9 is a diagrammatic perspective view of an air flow control valve used in the mixture supply device shown in FIGS. 1 to 4;

FIG. 10 is a table of partial cross-sectional views showing the shapes of the restrictions in two inlet passageways that change in state with the rotation of the air flow control valve of FIG. 9 in the multiple-throttle mechanism of the mixture supply device of the present invention;

FIG. 11 is a diagrammatic cross-sectional view showing the flow of the air existing when the restriction in a low-flow inlet passageway is opened by the air flow control valve of FIG. 9;

FIG. 12 is a diagrammatic cross-sectional view showing the flow of the air existing when the restrictions in both low-flow and high-flow inlet passageways are opened by the air flow control valve of FIG. 9;

FIG. 13 is a graph showing the relationship between the opening state of the air flow control valve of FIG. 9 and the relative opening cross-sectional area of a restriction formed in the inlet passageway;

FIG. 14 is a graph showing the relationships between engine speed and cylinder air inlet efficiency, established with the air flow control valve of FIG. 9 being fixed to a fully open position and a half-open position;

FIG. 15 is a graph showing, in the engine where the mixture supply device with the air flow control valve of FIG. 9 was mounted under the air inlet system of FIG. 7, changes in cylinder air inlet efficiency due to changes in the relative opening area of the valve during 1,500-rpm rotation of the engine;

FIG. 16 is a diagrammatic perspective view of an air flow control valve having openings different from those of FIG. 9 in terms of shape;

FIG. 17 is a sequence of partial cross-sectional views showing the vicinity of inlet passageways from the outlet side relative to the corresponding cylinder when the air flow control valve shown in FIG. 16 was mounted in the multiple-throttle mechanism and then the opening state of the valve was changed;

FIG. 18 is a set of partial cross-sectional views showing the vicinity of inlet passageways from the outlet side relative to the corresponding cylinder when the air flow control valve shown in FIG. 16 was mounted in the multiple-throttle mechanism and then the opening state of the valve was changed;

FIG. 19 is a cross-sectional view equivalent to FIG. 4, showing the mixture supply device using an air flow control valve of the type formed with one restriction in each inlet passageway;

FIG. 20 is a diagrammatic perspective view of the sealed structure in an air flow control valve of the type formed with a restriction at both inlet and outlet sides in one passageway;

FIG. 21 is a table of partial cross-sectional views illustrating the formed state and sealed state of the restrictions in two inlet passageways that change in state with the rotation of the air flow control valve of FIG. 20 in the multiple-throttle mechanism of the mixture supply device of the present invention;

FIG. 22 is a set of partial cross-sectional views illustrating the operation of a movable seal in accordance with the presence/absence of a differential pressure between the upstream and downstream of the air flow control valve shown in Fig. 20;

FIG. 23 is a diagrammatic perspective view illustrating the sealed structure in an air flow control valve of the type formed with one restriction in one passageway;

FIG. 24 is a set of cross-sectional views showing the multiple-throttle mechanism in the mixture supply device of the present invention where a sealed structure having a guide groove and a movable sealing member is constructed at the air flow control valve side and the casing side;

FIG. 25 is a cross-sectional view of the multiple-throttle mechanism in that mixture supply device of the present invention which has a sealed structure of the type where a sealing effect is made variable by operating an electromagnet containing a magnetic movable sealing member in the seal reinforcement portion at the casing side;

FIG. 26 is a set of partial cross-sectional views illustrating how the movable sealing member shown in FIG. 25 operates by the action of the electromagnet in the multiple-throttle mechanism used in the mixture supply device of the present invention;

FIG. 27 is a set of cross-sectional views showing the multiple-throttle mechanism in that mixture supply device of the present invention which is constructed so that by reducing the curvature of a valve insertion hole in the casing section for achieving a greater sealing effect, the sealing effect is increased particularly when the movable sealing member moves past the curvature reducer;

FIG. 28 is a diagrammatic perspective view of the multiple-throttle mechanism in that mixture supply device of the present invention which is constructed so that the diameter of the bearing installation section in the air flow control valve is reduced and during the occurrence of the resulting differential pressure between the upstream and downstream of the valve, the sealing effect of the movable sealing member is increased by the deformation of the bearing installation section;

FIG. 29 is a set of partial cross-sectional views illustrating how, in the multiple-throttle mechanism in that mixture supply device of the present invention, the movable sealing member shown in FIG. 28 increases in sealing effect by the deforming action of the bearing installation section;

FIG. 30 is a cross-sectional view equivalent to FIG. 4, showing the mixture supply device having an inlet passageway and an air-assist-type mount connected by an assist air supply passageway;

FIG. 31 is a cross-sectional view equivalent to FIG. 4, showing the mixture supply device in which an inlet passageway and an air-assist-type mount are connected by an assist air supply passageway and an air stream is supplied to the air-assist-type fuel spraying mechanism through the assist air supply passageway;

FIG. 32 is a diagrammatic view of the mixture supply device in which the assist air supply passageway for supplying an air stream to the fuel spraying mechanism is opened to a high-flow inlet passageway;

FIG. 33 is a diagrammatic perspective view of a mixture supply device of the type that contains two motors, two drives, and two air flow control valves inside, each of these elements controlling four inlet passageways of air flow;

FIG. 34 is a diagrammatic perspective view of a mixture supply device of the type that contains four motors, four drives, and four air flow control valves inside, each of these elements controlling four inlet passageways of air flow;

FIG. 35 is a diagram showing an air velocity pattern of the air flow control valve according to the present invention;

FIG. 36 is a set of partial cross-sectional views of the mixture supply device, showing the operating state of the air flow control valve;

FIG. 37 is a set of diagrammatic views showing the shapes of the opening in the air flow control valve under different states;

FIG. 38 is a diagram showing the mixture supply device of the present invention, mounted in an in-line multi-cylinder internal-combustion engine;

FIG. 39 is a graph in which the HC emission levels detected during combustion in a typical cylinder of a multi-cylinder internal-combustion engine are compared with those of a conventional fuel injection valve; and

FIG. 40 is a graph in which the HC emission pattern during the time from engine start to first idling is compared with a pattern obtained using a conventional fuel injection valve.

### DESCRIPTION OF THE INVENTION

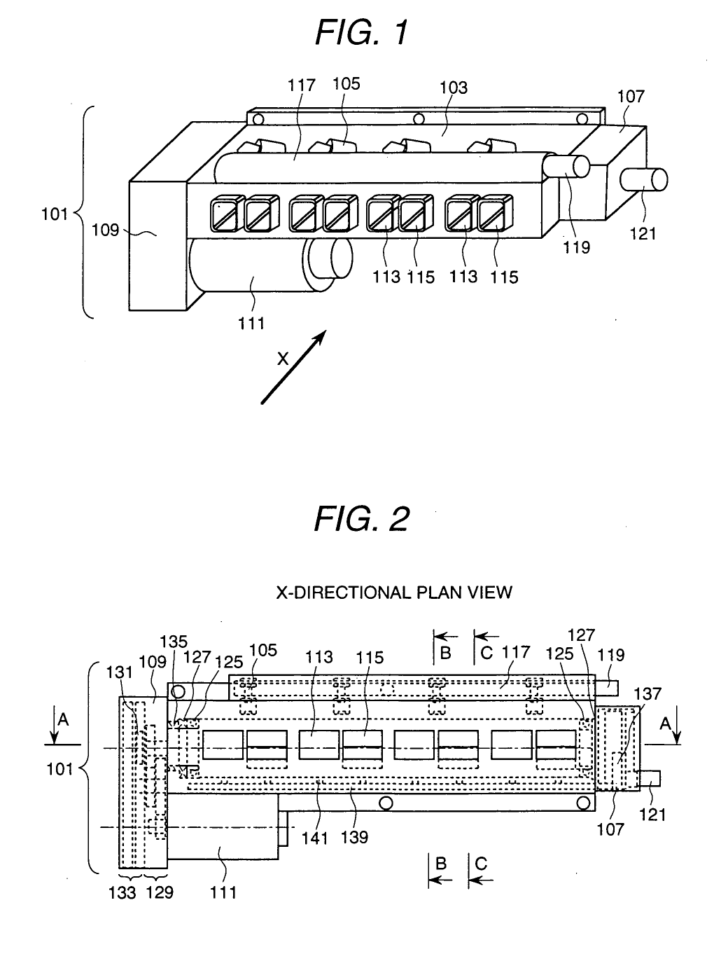

FIG. 1 provides an external view of a mixture supply device 101 pertaining to the present invention as applied to an in-line four-cylinder automobile engine having two inlets per cylinder. This mixture supply device is constructed mainly of a multiple-throttle mechanism 103, a fuel spraying mechanism 105, an exhaust recirculating mechanism 107, and an integrated controller 109. The multiple-throttle mechanism 103 is provided with a built-in air flow control valve capable of controlling the flow rate of air and the flow of the air integrally for each inlet passageway, and it has, at the bottom, a motor 111 for driving the air flow control valve. On a front lateral side, eight openings are provided as air inlets, and every two adjacent ports at the end take in air for one cylinder of the engine. One of the two paired inlets is a low-flow inlet 113 and the other is a high-flow inlet 115. Although not shown in the figure, openings to function as mixture outlets corresponding to the respective inlets are provided on a rear lateral side, with the inlets and the outlets being connected by an inlet passageway section, i.e., passageways, inside the multiple-throttle mechanism 103. The fuel spraying mechanism 105 has one end connected to a fuel feeder 117 present at a top of the multiple-throttle mechanism 103, and it has a body fixed thereto. A fuel pipe which extends from a fuel tank of an automobile to a fuel pump thereof is connected to a fuel supply port 119, and fuel is introduced into the fuel feeder 117 through the fuel pipe and is sprayed into the inlet passageways by the fuel spraying mechanism 105. The exhaust recirculating mechanism 107 has a recirculated-exhaust control valve built thereinto, and it controls the quantity of recirculated exhaust introduced from a recirculated-exhaust introduction port 121 and distributes the exhaust to each inlet passageway.

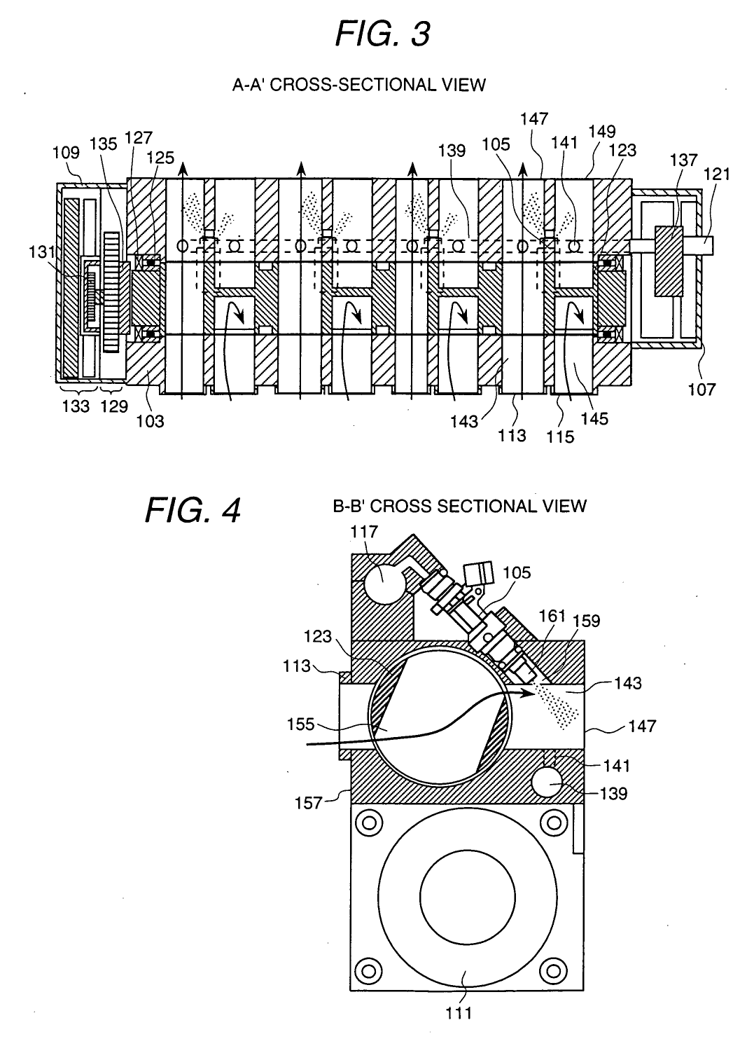

FIG. 2 is a plan view of the mixture supply device 101 as seen in the direction of arrow X in FIG. 1. Referring to FIG. 2, the front lateral side is an outlet side to the cylinders. The multiple-throttle mechanism 103 has an air flow control valve 123 (shown in FIG. 3) constructed therein, and both ends of the air flow control valve 123 are rotatably supported by bearings 125. At both ends of the air flow control valve 123, sealing members 127 are also provided so that, the air, fuel and recirculated exhaust flowing inside the multiple-throttle mechanism 103 are prevented from leaking to the exhaust recirculating mechanism 107. The torque of the motor 111 installed at the bottom of the multiple-throttle mechanism 103 is transmitted to the air flow control valve 123 through a drive 129 included in a casing of the integrated controller 109, thereby causing a rotary motion to be applied to the air flow control valve 123. One end of the air flow control valve 123 is connected to a throttle position sensor 131, from which rotational angle information on the rotary motion of the air flow control valve 123 is output as electrical signals, and these signals are then transmitted to an integrated control circuit 133. The air flow control valve 123 also has a default spring section 135, so that, when electric power to the motor 111 is cut off, the rotational angle of the air flow control valve 123 (this angle is also the rotational angle of a rotary body described later in this Specification), namely, the opening state of the valve, is reset to a previously set value by action of the spring force of the default spring section 135. Inside the exhaust recirculating mechanism 107, a recirculated-exhaust control valve 137 is provided so that, when the recirculated exhaust introduced from the recirculated-exhaust introduction port 121 enters the mixture, the quantity of entry is controlled. Recirculated exhaust is distributed, and it enters, from a recirculated-exhaust entry port 141, that is smaller than the recirculated-exhaust distribution pipe 139 in terms of diameter, to the inside of each inlet passageway through the recirculated-exhaust distribution pipe 139 provided at the bottom of the multiple-throttle mechanism 103.

FIG. 3 is a cross-sectional view of taken along line A-A′ in FIG. 2. The lower side and upper side in FIG. 3 are an air inlet side and a cylinder side of the engine, respectively. In the multiple-throttle mechanism 103, eight inlets are provided, as shown on a lower lateral side of the figure, and every two adjacently disposed inlets, one serving as a low-flow inlet 113 and one serving as a high-flow inlet 115, take in air for one cylinder of the engine. These inlets communicate with respective low-flow inlet passageways 143 and high-flow inlet passageways 145, and they are further connected to respective low-flow mixture outlets 147 and high-flow mixture outlets 149, both provided on an upper lateral side of the figure. The low-flow mixture outlets 147 and the high-flow mixture outlets 149 are further connected to the respective passageways leading to the mixture inlet ports in the cylinders of the engine. The air flow control valve 123 is a rotary body, which coordinates with its peripheral enclosure to form a restricting portion (shield and restriction), and it is installed so that the rotary body intersects halfway with the low-flow inlet passageways 143 and the high-flow inlet passageways 145, and has a previously machined opening of a shape (opening shape) corresponding to each inlet passageway. The shape of the opening formed in each inlet passageway is determined by the relationship between a wall surface of the inlet passageway and an opening machined in the air flow control valve; and, by the rotary motion of the air flow control valve, which is driven by the motor 111, the shape of the restricting portion is determined in accordance with the relationship between a predetermined rotational angle (phase) and the shape of the restricting portion in the air flow control valve. Thereby, the quantity of air supplied to the cylinder through each inlet passageway and the flow of the air are controlled. The fuel spraying mechanism 105 is installed between the low-flow inlet passageways 143 and the high-flow inlet passageways 145, and a fuel spraying port is present downstream from the air flow control valve 123, near the cylinder. Thus, fuel is spray-supplied from the spraying port to both inlet passageways. The recirculated-exhaust entry port 141 is also present downstream from the air flow control valve 123, near the cylinder. This recirculated-exhaust entry port 141 is provided either at the opposite side relative to the fuel spraying port, across the inlet passageway, or in a circumferential direction of at least the inlet passageway, at a position different from that of the fuel spraying port; and, thus, by utilizing the flow and heat of recirculated exhaust near the wall surface of the inlet passageway, the fuel sprayed into the inlet passageway is prevented from sticking to the wall surface thereof. The structure as described above ensures that a mixture, which is obtained by mixing air, fuel and recirculated exhaust, is discharged from the low-flow mixture outlets 147 and the high-flow mixture outlets 149 and is supplied to the cylinder interior, functioning as the combustion chamber of the engine.

FIG. 4 is a cross-sectional view taken along line B-B′ in FIG. 2. The left side and the right side in FIG. 4 are the inlet side and the cylinder side of the engine, respectively. Air is taken in from the inlet 113 and passed into the inlet passageway 143, from which the air, after having its flow rate and flow controlled by the air flow control valve 123, which is installed halfway in the inlet passageway, is then discharged towards the corresponding cylinder of the engine. The air flow control valve 123 can be rotated both clockwise and counterclockwise; it has a restriction formed between an opening 155 and an inlet passageway formed in a casing 157 of the multiple-throttle mechanism; and, it controls the flow rate and flow of the air that passes through the restriction. The flow of the air is controlled either by, for example, providing differences in air velocity and air flow rate between inlet passageways and then activating the swirl flow within the cylinder by use of an imbalance created after discharge; by varying the spatial distributions of the velocity and flow rate in an inlet passageway and thereby generating a rotating flow, a swirl flow, or the like; and, at low flow rate, by deflecting the air flow in the direction of the fuel spraying port and thus accelerating the atomization of sprayed fuel by use of the air flow. Also, when the air flow control valve 123 is rotated clockwise and the restriction is opened, this restriction is opened from the area adjacent the fuel spraying mechanism 105 to facilitate further concentration of the air stream in the spraying port and thereby to allow easy atomization by causing the high-speed air stream to collide with the fuel particles. Conversely, when the air flow control valve 123 is rotated counterclockwise and the restriction is opened, this restriction is opened from the side opposite to that of the fuel spraying mechanism 105, thus making it easy to guide the high-speed air flow to a wall surface and thereby to suppress the tendency for the sprayed fuel stick to the wall surface. The fuel spraying mechanism 105 has one end connected to the fuel feeder 117 in order to receive fuel, and it is fixed within a bore 159 which communicates with an inlet passageway machined in the multiple-throttle mechanism 103. The fuel injection port 161 of the fuel spraying mechanism 105 is opened downstream from the air flow control valve 123, near the cylinder, and it injects fuel towards a low-flow inlet passageway and a high-flow inlet passageway. Beneath each inlet passageway, the recirculated-exhaust distribution pipe 139 is disposed, so that recirculated exhaust is introduced via the recirculated-exhaust entry port 141 into the inlet passageway. The recirculated-exhaust entry port 141 is provided either at a position opposite to the fuel injection port 161, in the inlet passageway, or at a different position in a circumferential direction, and it is used to supply recirculated exhaust to a section at which fuel is expected to collide with a wall surface, so that the flow of recirculated exhaust is able to prevent, by use of heat and flow, sprayed fuel from sticking to the wall surface. The air, fuel, and recirculated exhaust thus introduced into each inlet passageway form a mixture, and, after fluidity has been given thereto, the mixture is discharged from the mixture outlets 147 towards the cylinders of the engine.

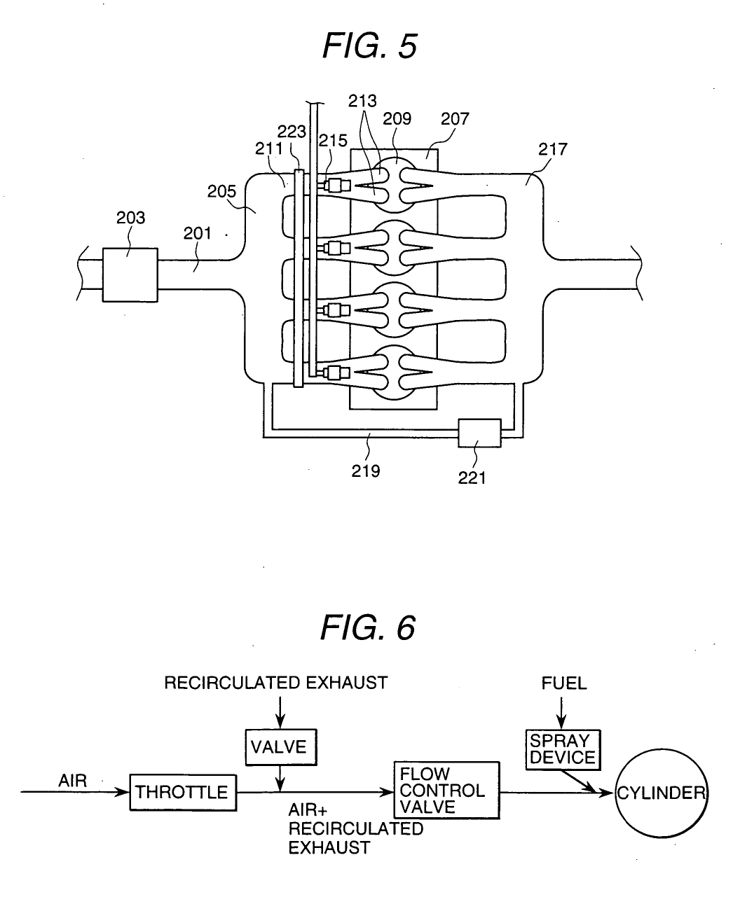

FIG. 5 shows the configuration of the air inlet system in a conventional type of gasoline engine. After air is passed through an air cleaner and taken from the atmosphere into an air inlet pipe 201, the air has its flow rate controlled by a restriction formed in a throttle device 203 located along the air inlet pipe, and this air is then sent to a surge tank 205. From the surge tank 205, individual air inlet pipes 211 diverge towards a respective cylinder 209 in an engine body 207 and are connected to a respective cylinder air inlet 213. Although one to three cylinder inlets 213, each having an air inlet valve which opens and closes in relationship with the rotational phase of a crankshaft in the engine, are provided for each cylinder, the independent air inlet pipe 211 is provided in one place, or it diverges according to the particular number of air inlets in the cylinder. Along the independent air inlet pipe, an air flow control valve 203 for controlling air flow is installed, and a fuel spraying device 215 also is installed at a downstream side thereof to supply fuel in sprayed form into the individual air inlet pipe. An exhaust pipe 217 and the surge tank 205, or the air inlet pipe, are connected by an exhaust recirculating connection 219, and part of the exhaust gases taken out from the exhaust pipe 217 is quantitatively controlled by a recirculated-exhaust control device 221, located on the route, and is returned to the air inlet side. Each device mentioned above is a separate component and requires its own piping and wiring. During engine assembly, therefore, each such device needs to be piped and wired.

A flowchart of the method of mixture formation in such an air inlet system is shown in FIG. 6. During the formation of the mixture to be supplied to each cylinder 209, the quantities of air, fuel and recirculated exhaust are controlled by controlling three different devices, namely, the throttle device 203 existing along the air inlet pipe 201, the fuel spraying device 215 existing along the independent air inlet pipe 211, and the recirculated-exhaust control device 221 present along the exhaust recirculating route 219. The response time for controlling the mixture according to the particular engine output command and the combustion state is determined as a result of considering, in addition to the respective operating response times of the throttle device 203, the fuel spraying device 215, and the recirculated-exhaust control device 221, the time from the passage of air, fuel and recirculated exhaust through each control device to respective arrivals at the cylinder.

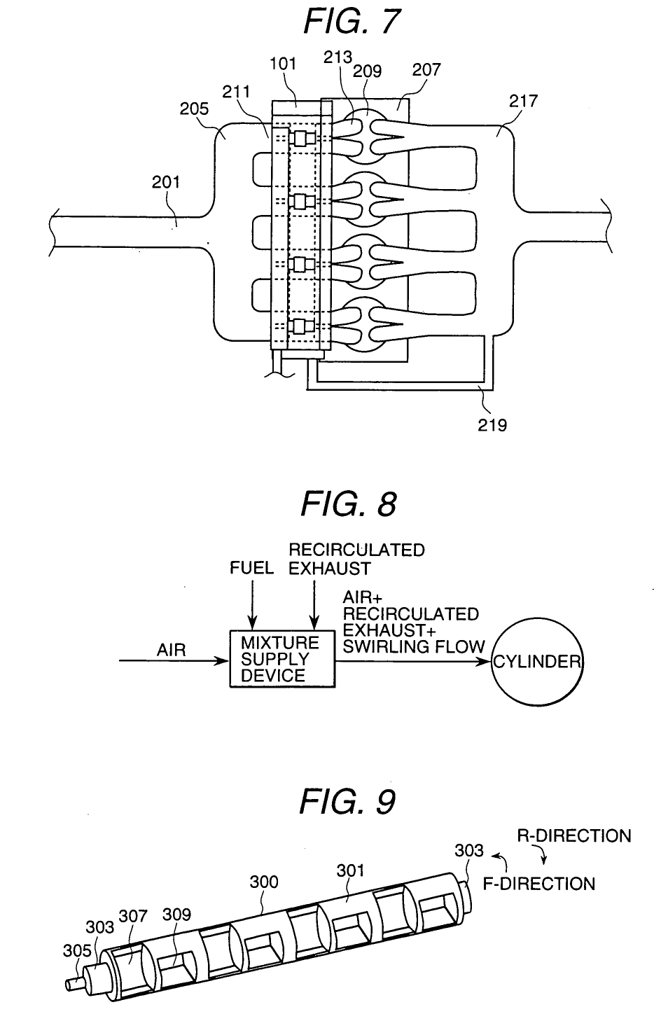

FIG. 7 shows the configuration of the air inlet system in an engine which uses the mixture supply device of the present embodiment. As shown in this figure, the mixture supply device is installed along the independent air inlet pipe 211. The exhaust recirculating route 219 extending from the exhaust pipe 217 and the fuel piping extending from the fuel pump are connected directly to the mixture supply device. In such a system, air, fuel and recirculated exhaust are controlled at a position proximate to the cylinder; and, since the delay in transport of this mixture to the cylinder is reduced, rapid response can be achieved with respect to the accelerator operations produced by the driver. Since the multiple-throttle mechanism, fuel spraying mechanism, and exhaust recirculating mechanism in this mixture supply device are connected to the integrated controller through the internal wiring of the mixture supply device in order to obtain control signals and receive electric power, it is possible to reduce and adjust the quantity of wiring leading to the outside of the mixture supply device. As a result, the engine assembly workload can be reduced, and the manufacturing expenses can be reduced as well.

A flowchart of the mixture formation in such an air inlet system is shown in FIG. 8. Since the quantities of air, fuel and recirculated exhaust which enter into the mixture are all controlled inside the mixture supply device 101, it also becomes possible to reduce variations in response to each quantity of entry. There is no need to separately install a throttle device 203 or recirculated-exhaust control device 221, as used in conventional structure. There is no problem, however, even if such devices are installed as countermeasures against possible malfunction of the mixture supply device 101. In the conventional air inlet system as shown in FIG. 5, since a downstream section of the cylinder is depressurized below atmospheric pressure by the throttle device 203, the air inlet pipe 201 and surge tank 205 at the downstream side are required to carry out a function to maintain pressure. When the mixture supply device in FIG. 7 is used, however, since the upstream side of the mixture supply device 101, i.e., a large portion at the air cleaner side, is maintained at atmospheric pressure, there is no need to take a special measure for maintaining pressure at that section. For this reason, it becomes possible to manufacture the air inlet pipe and the surge tank at lower costs and thus to reduce the engine manufacturing expenses.

An external view of the air flow control valve 123 is shown in FIG. 9. This valve is constructed in the form of a rotary body 300, having air flow controllers 301 formed in the rotary body 300, bearing-mounting sections 303, and an opening state sensor connector 305. In the air flow controllers 301, eight openings each corresponding to an inlet passageway, namely, inlet passageways 307 and 309 (hereinafter, described as openings), are formed in the cylindrical member of the rotary body 300. The combination of a low-flow opening 307 and high-flow opening 309 control the quantity of inlet air for one cylinder. Both openings may be freely machined so as to exhibit different opening characteristics with respect to circumferential rotations of the air flow controllers 301. In this example, however, the low-flow opening 307 is opened in an angle range that is twice that of the high-flow opening 309. The bearing-mounting sections 303 correspond to the bearings mentioned earlier, and they are built so as to be rotatable either in the direction F or the direction R inside the multiple-throttle mechanism 103. In other words, they are adapted to be rotatable in a reversibly bi-directional manner. The position sensor connector 305 connects with the throttle position sensor 131 and transmits rotational angle information of the air flow control valve 123 to the sensor.

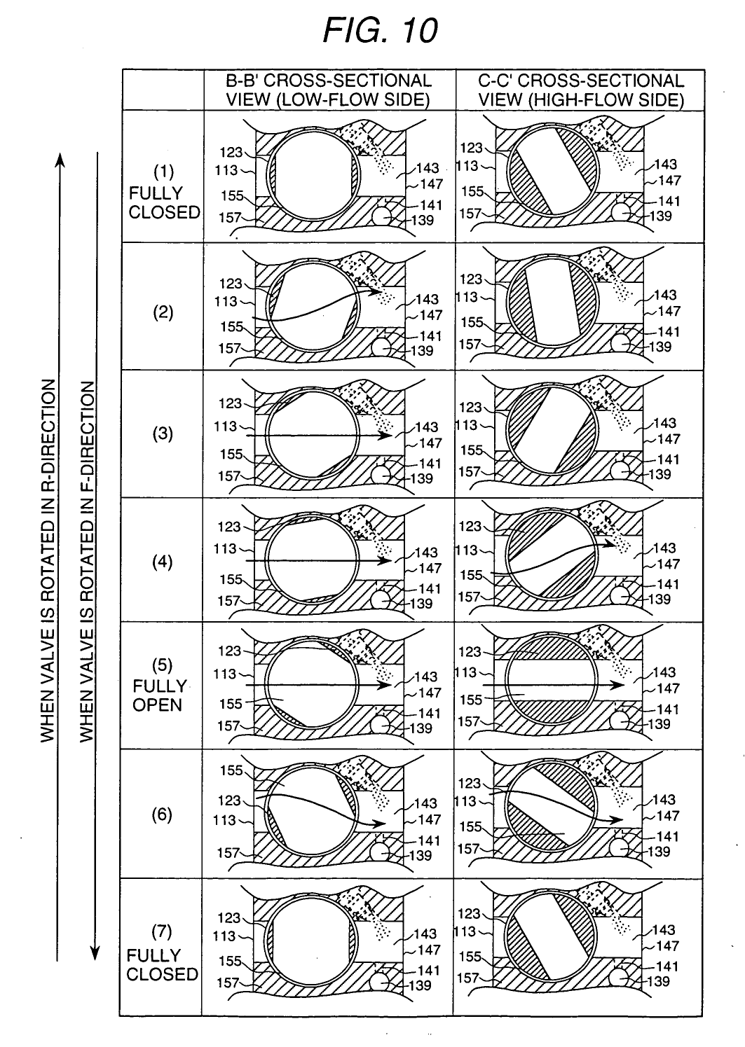

The operational characteristics of the air flow control valve 123 shown in FIG. 9 will be described below with reference to FIG. 10. The cross-sectional views B-B′ in FIG. 10 show a taken along line section B-B′ in FIG. 2, particularly of a section near an inlet passageway, and they illustrate the characteristics of the air flow control valve 123 operating when air flows through the low-flow inlet passageway 143. Similarly, the cross-sectional views C-C′ in FIG. 10 show a section taken along line C-C′ in FIG. 2, particularly of a section near an inlet passageway, and they illustrate the characteristics of the air flow control valve 123 operating when air flows through the high-flow inlet passageway 145. When the state in FIG. 10(1) is taken as an initial fully closed state and the air flow control valve 123 shown in FIG. 9 is rotated in the direction F, the restriction gradually opens from the low-flow side, with the high-flow side remaining in a fully closed state, and the low-flow side fully opens with the state shown in FIG. 10(3) being maintained. When, from this state, the rotary body 300 is further rotated in the direction F, the restriction at the high-flow side starts to open, with the low-flow side maintaining its restriction fully open; and, soon, as shown in FIG. 10(5), the restrictions in both inlet passageways 310 and 311 become fully open. When the rotary body 300 is further rotated in the direction F, the sizes of the restriction on both the low-flow and the high-flow sides are reduced almost similarly, and, as shown in FIG. 10(7), eventually the restrictions fully close once again. Conversely, When the rotary body 300 is rotated in the direction R, the sizes of the restrictions on both the low-flow and high-flow sides, as shown in FIG. 10(6), increase similarly from the fully closed state in FIG. 10(7), and then, as shown in FIG. 10(5), the restrictions become fully open. When the rotary body 300 is further rotated in the direction R, the restriction at the high-flow side, as shown in FIG. 10(4), decreases in size, with the low-flow side maintaining its restriction fully open; and, as shown in FIG. 10(3), only the restriction at the high-flow side fully closes. When, from this state, the rotary body 300 is further rotated in the direction R, only the restriction at the low-flow side decreases in size, with the high-flow side maintaining its restriction fully closed; and, finally, the low-flow side restriction fully closes as shown in FIG. 10(1). In this way, the air flow control valve 123 shown in FIG. 9 can be used in such a manner that, depending on the rotational angle of the rotary body 300, the opening states of the restrictions are increased or reduced to provide the quantity of air with a difference between the low-flow and high-flow sides, as seen in the sequence from FIG. 10(1) to FIG. 10(5), or the quantities of air at both the low-flow and high-flow sides in the region, as seen from FIG. 10(5) to FIG. 10(7), are increased or reduced so as to become equal. Also, whether the restriction opens from the area of the fuel spraying mechanism within the inlet passageway or from the opposite side changes according to the particular direction of rotation. When the atomization of the fuel is to be accelerated in cases such as at low flow rate, the rotary body 300 is rotated in the direction F, i.e., clockwise as seen in FIG. 10. This starts the opening of the restrictions from the one closer to the fuel spraying mechanism, thus concentrating a high-speed air stream at the fuel spraying mechanism or its fuel spraying port, and, consequently, creating a collision between the air stream and the fuel particles so as to atomize the fuel. Conversely, when prevention of fuel from sticking to the wall surface of the inlet passageway is required more than the above, the rotary body 300 is rotated in the direction R, i.e., counterclockwise as seen in FIG. 10. This starts the opening of the restrictions with the one more distant from the fuel spraying mechanism, thus concentratedly inducting the air stream to the vicinity of a location at which sprayed fuel collides with the wall surface of the inlet passageway, and, consequently, suppressing fuel from sticking to the wall surface and producing removal of sticking fuel.

As described earlier, recirculated exhaust is distributed and enters, from the recirculated-exhaust entry port 141, which is smaller than the recirculated-exhaust distribution pipe 139 in terms of diameter, to the inside of each inlet passageway through the recirculated-exhaust distribution pipe 139 provided at the bottom of the multiple-throttle mechanism 103. As shown in the figure, a restriction is disposed adjacent not only to the fuel spraying port, but also to the recirculated-exhaust entry port 141, such that fuel, inlet air and recirculated exhaust are efficiently mixed near an exit of the air flow control valve 123.

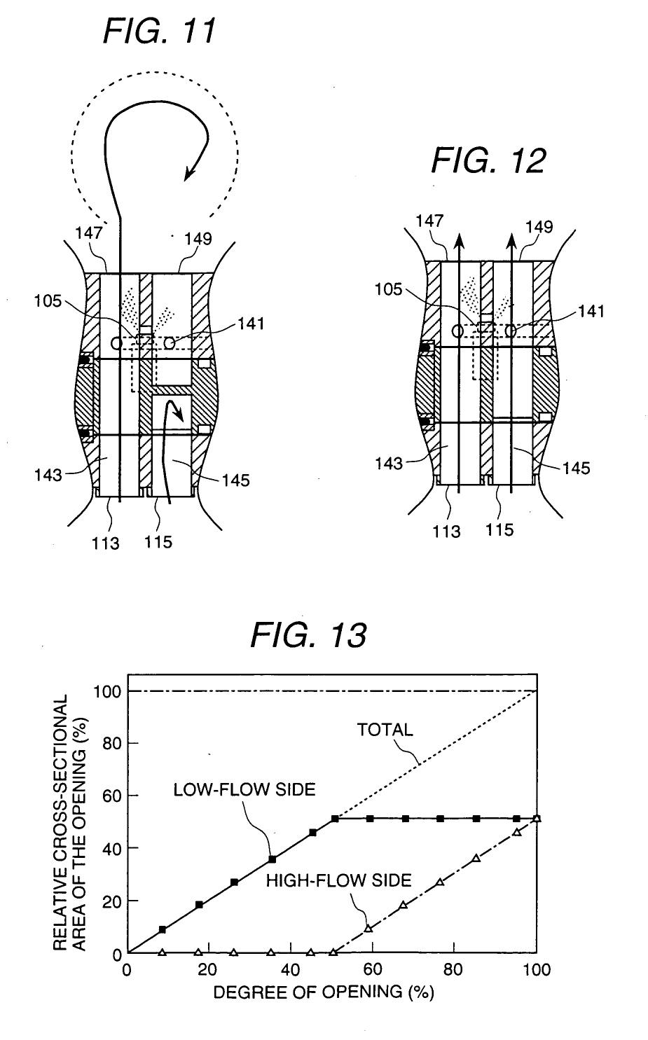

Even if the same quantity of air is to be supplied as a whole, when control is used that provides a difference between the quantities of air passing through the inlet passageways at the low-flow and high-flow sides, it becomes possible to increase the inertia by concentrating a greater quantity of air in the inlet passageway at the low-flow side and increasing the velocity thereof, and thus to more efficiently supply a larger quantity of mixture to the cylinder by utilizing the resulting inertial effect. Such an increase in the efficiency of the air intake to this cylinder allows greater torque output to be obtained, even at the same engine speed, and, as a result, the fuel consumption in the automobile can be reduced. Also, as shown in FIG. 11, by providing a difference in the flow rate of the mixture flowing along two flow routes connected to one cylinder, a swirl flow can be produced inside the cylinder, and, although not shown in the figure, vertical and other rotating flows can be activated. Control of these flows can not only increase the flame propagation rate during combustion and thereby yield greater engine output, but it also can improve the mixture state and the combustion state and reduce the occurrence of harmful exhaust. Conversely, even when air flow control valves of the same type are used, since the sizes of the restrictions in both the low-flow and high-flow inlet passageways can be equally increased/reduced by utilizing the region from FIG. 10(5) to FIG. 10(7), a mixture can also be supplied to the inside of the combustion chamber more smoothly by, as shown in FIG. 12, equally inducting air into both inlet passageways. Even when the same flow rate of air is required, in the case where, judging from the operating state of the engine and the accelerator operations of the driver, a larger quantity of air flow is necessary, the state as shown in FIG. 11 can be generated, or, in the case where an even more equal flow is necessary, the state as shown in FIG. 12 can be generated.

As described above, in a mixture supply device for use in a multi-cylinder type of internal-combustion engine, which is installed so that air inlet passageway sections connected to respective cylinders are diverged and then re-converge, the mixture supply device comprises: a first construction block in which there are a rotary body 300, a passageway section 310 formed inside the rotary body 300, and an opening 307 formed on part of an outer periphery of the rotary body 300; and a second construction block in which there are a rotary body 300, a passageway section 311 formed inside the rotary body 300, and an opening 309 formed on part of the outer periphery of the rotary body 300. In this mixture supply device, there is an air flow control valve 123 provided with a rotating device for rotating the rotary body 300 in a reversibly bi-directional manner, the air flow control valve 123 being further formed with a restricting portion at which restrictions in the first and second construction blocks each change in shape according to a particular rotary motion of the rotary. There is also a multiple-throttle mechanism 103 that contains the air flow control valve 123; and, there is a fuel spraying mechanism 105 having a fuel spraying port disposed in proximity to the restricting portion in the air flow control valve 123.

Also, in a mixture supply device for use in a multi-cylinder type of internal-combustion engine, which is installed on an air inlet pipe that is adapted so as to diverge and then re-converge air inlet passageway sections connected to respective cylinders, the mixture supply device comprises: a first construction block in which there are a rotary body 300, a passageway section 310 formed inside the rotary body 300, and an opening formed on part of an outer periphery of the rotary body 300; and a second construction block in which there are a passageway section 311 formed inside the rotary body 300 and an opening 309 formed on part of the outer periphery of the rotary body 300. In this mixture supply device, there is an air flow control valve 123 provided with a restricting portion at which restrictions in the first and second construction blocks change in shape so as to differ from each other according to a particular rotary motion of the rotary body 300. There is also constructed a multiple-throttle mechanism 103 that contains the air flow control valve 123 inside; and there is a fuel spraying mechanism 105 having a fuel spraying port disposed in proximity to the restricting portion in the air flow control valve 123.

In addition, a mixture supply device for use in a multi-cylinder type of internal-combustion engine, which is installed on an air inlet pipe that is adapted to diverge and then re-converge air inlet passageway sections connected to respective cylinders, comprises: a first construction block in which there are a rotary body 300, a passageway section 310 formed inside the rotary body 300, and an opening 307 formed on part of an outer periphery of the rotary body 300, and a second construction block in which there are a passageway section 311 formed inside the rotary body 300 and an opening 309 formed on part of the outer periphery of the rotary body 300. In this mixture supply device, there is an air flow control valve 123 provided with a restricting portion at which restrictions in the first and second construction blocks change in shape so as to differ from each other when the rotary body 300 rotationally moves. There is also a multiple-throttle mechanism 103 that contains the air flow control valve 123; there is a fuel spraying mechanism 105 having a fuel spraying port disposed in proximity to the restricting portion in the air flow control valve 123; a recirculated-exhaust entry port 141 is disposed in proximity to the restricting portion in the air flow control valve 123; and an exhaust recirculating mechanism 107 is provided, so that controlled inlet air, sprayed fuel particles, and recirculated exhaust are mixed near a downstream side of the restricting portion.

Furthermore, in any one of the above-mentioned mixture supply devices for use in an internal-combustion engine, two restrictions are provided in a rotational direction of each air flow control valve 123.

Besides, in any one of the above-mentioned mixture supply devices for use in an internal-combustion engine, a rotational angle of said rotary body is set for one restriction in the air flow control valve 123 to ensure that an outlet direction of inlet air faces the vicinity of the fuel spraying port 105 so that a high-speed air stream is supplied to the vicinity of the fuel spraying port 105, thereby to cause air to collide with a fuel injection stream sprayed therefrom.

Besides, in any one of the above-mentioned mixture supply devices for use in an internal-combustion engine, the opening 307 in the first construction block and the opening 309 in the second construction block are formed to have different sizes, both openings being disposed so as to differ in the direction of opening thereof.

The change characteristics of the opening area with respect to the opening state existing when the air flow control valve shown in FIG. 9 is rotated in the direction F and then changed from the fully closed state as seen in FIG. 10(1) to the fully open state as seen in FIG. 10(5), are shown in FIG. 13. The opening cross-sectional area within the inlet passageway, per cylinder with respect to the opening state, at values up to the first 50%, is determined by the opening of the low-flow opening 307, and, at greater values is determined by the opening of the high-flow opening 309.

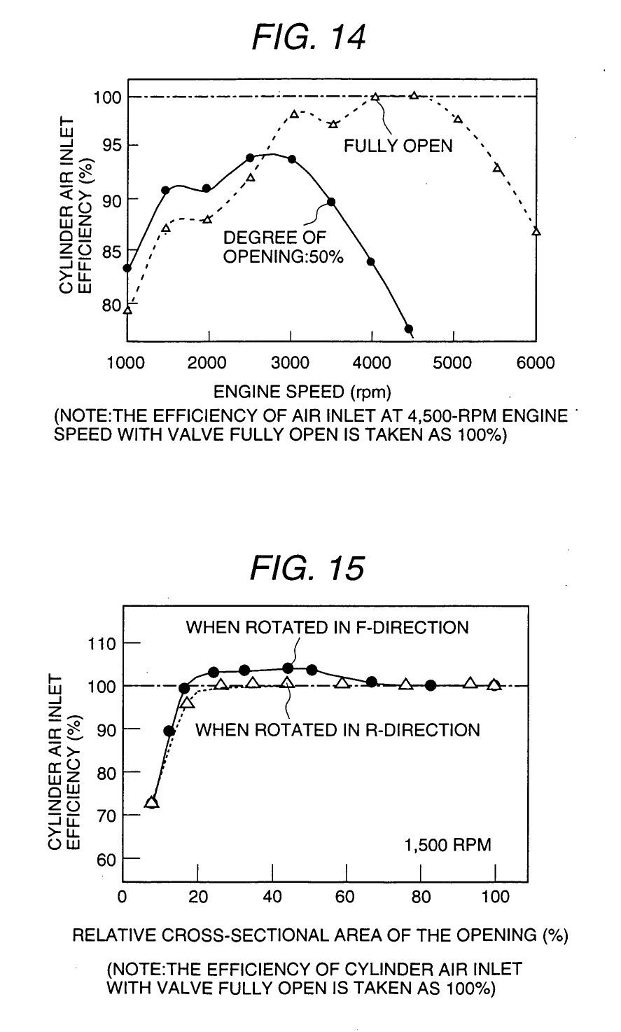

Changes in the efficiency of the cylinder air inlet with respect to various engine speeds, measured when the mixture supply device using this valve in the multiple-throttle mechanism is applied to an in-line four-cylinder automobile engine having two inlets per cylinder, are shown in FIG. 14. The dashed line on the graph represents the relationship existing when the air flow control valve is fully open as seen in FIG. 10(5), and the maximum value under this condition is taken as 100% on the Y-axis of the graph. The dashed line indicates that the efficiency of the cylinder air inlet tends to become a maximum under the operating conditions existing when this engine runs at 4,500 rpm, and to decrease at other speeds. The solid line on the graph represents the relationship existing when the air flow control valve is 50% open and, as shown in FIG. 10(3), only the low-flow inlet passageway is fully open. The solid line indicates that, under the low-speed operating conditions of 2,500 rpm in engine speed, the efficiency of the air inlet exceeds that obtained under the fully open states of both inlet passageways, as denoted by the dashed line. These results indicate that, when the air flow is concentrated in one inlet passageway, it is possible for a greater inertial effect to be created, and, depending on operating conditions, for the efficiency of the cylinder air inlet to be improved over that obtained in the case of a full open state. In general, with a higher efficiency of the cylinder air inlet, greater torque can be generated at a given engine speed. Such control of the air flow control valve, therefore, makes it possible to increase the torque output under low-speed operating conditions of the engine and to reduce fuel consumption in the automobile by effecting further balance with respect to its transmission.

The efficiency of the cylinder air inlet, obtained when the opening cross-sectional area of the air flow control valve is changed during operation at an engine speed of 1,500 rpm, in particular, is shown in FIG. 15. The dashed line on the graph represents the relationship established when the air flow control valve of FIG. 9 is rotated from the fully closed state as seen in FIG. 10(7), in the direction R, and is changed to the fully open state as seen in FIG. 10(5). As the opening cross-sectional area, i.e., the size of the opening in the restriction, increases, the efficiency of the cylinder air inlet increases, and it becomes a maximum under a fully open state. The solid line represents the relationship established when the air flow control valve of FIG. 9 is rotated from the fully closed state as seen in FIG. 10(1), in the direction F, and is changed to the fully open state as seen in FIG. 10(5). In the region where the opening cross-sectional area becomes nearly 50%, i.e., where only the inlet passageway at the low-flow side is opened, the efficiency of the cylinder air inlet increases so as to surpass the relationship represented by the dashed line when the restrictions at both sides are equally opened, and the corresponding maximum value exceeds about 5%. In the region where the opening cross-sectional area exceeds 50% and both restrictions are open, a relationship almost equal to that represented by the dashed line is obtained.

As described above, in the mixture supply device using an air flow control valve such as shown in FIG. 9, since the torque output of the engine tends to differ according to the particular opening states of both inlet passageways, not only the sizes of the respective restrictions, even if the opening of the restrictions is increased with the accelerator operations of the driver, the torque output does not always increase in proportion to that increase. Accordingly, the integrated controller considers the accelerator operations of the driver, the operating state of the engine, and the opening state of the air flow control valve, and it efficiently controls the output of the engine by controlling the air flow control valve so as to provide the engine output requested by the driver. For example, when torque output can be increased by only half-opening the valve, rather than by fully opening it, even if the driver fully steps on the accelerator, a command is issued that only half-opens the restricting portion.

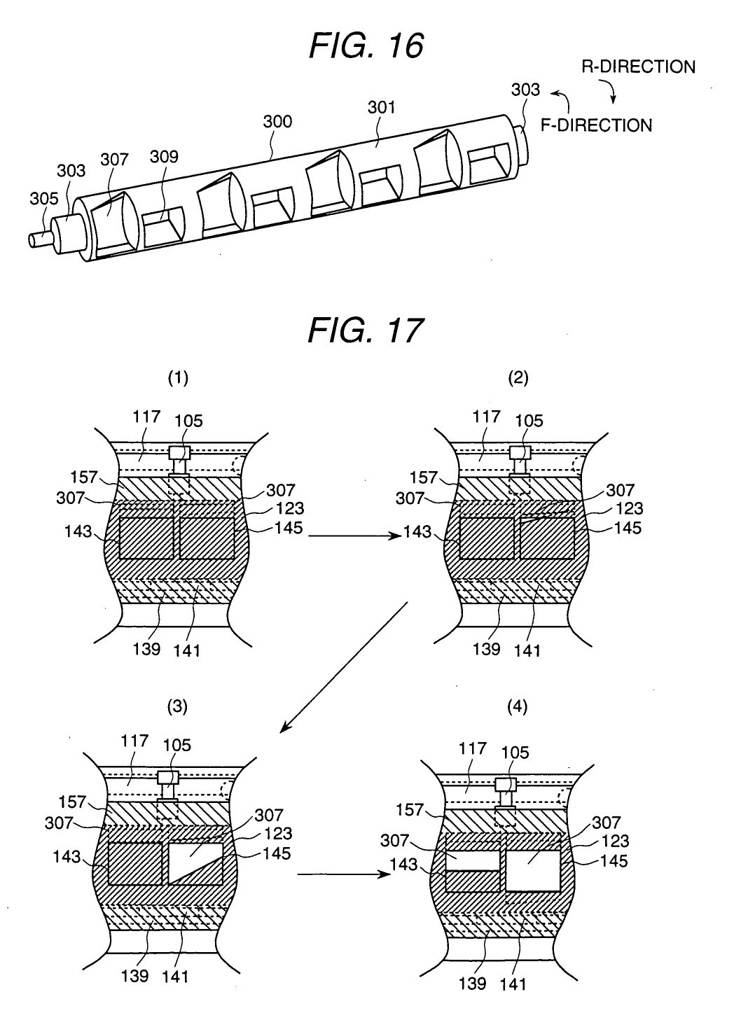

As an alternative to the shapes shown in FIG. 9, the shapes of the low-flow opening 307 and high-flow opening 309 machined in the air flow control valve 123 are determined so as to fit the particular purpose of control and the characteristics of the engine, and both openings are freely machined in the air flow controllers 301. For example, the air flow control valve of FIG. 16, when rotated in the direction F to open the restrictions, has the characteristic that the low-flow opening 307 gradually opens from a corner close to the fuel spraying port.

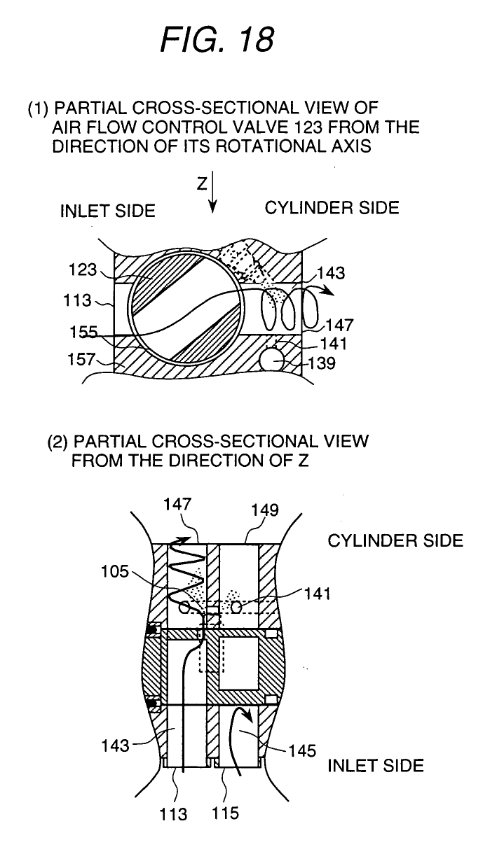

FIG. 17 is a set of partial cross-sectional views showing, from the outlet side, the inlet passageway for one cylinder, in the multiple-throttle mechanism using the valve of FIG. 16. When, from its fully closed state, as seen in FIG. 17(1), the air flow control valve shown in FIG. 16 is rotated in the direction F, opening of the restriction is, as shown in FIG. 17(2), started from the side close to the top of the fuel spraying section 105 of the low-flow inlet passageway 145, thereby, as shown in FIG. 17(3), increasing the opening of the restriction at the low-flow side. When the restriction at the low-flow side completely opens, the restriction at the high-flow side starts opening, as seen in FIG. 17(4), and soon it fully opens. The states hereafter are the same as those of the valve shown in FIG. 9. Under the states (2) and (3) of FIG. 17, since, inside the low-flow inlet passageway 145, the restriction opens in an offset manner towards an upper left portion, the air stream, after passing therethrough, activates the flow state within the inlet passageway by, for example, generating a swirl motion of the air therein, as shown in FIG. 18, or generating some other rotary motion, although not shown in the figure, depending on the particular opening shape of the restriction. The occurrence of this swirl flow, or the activation of the flow status, improves the mixed states of air, fuel and recirculated exhaust in the mixture, and it also contributes to activated air flow inside the cylinder, an improved flame propagation rate during combustion, and an improved combustion state, with the result that the occurrence of harmful exhaust can be suppressed.

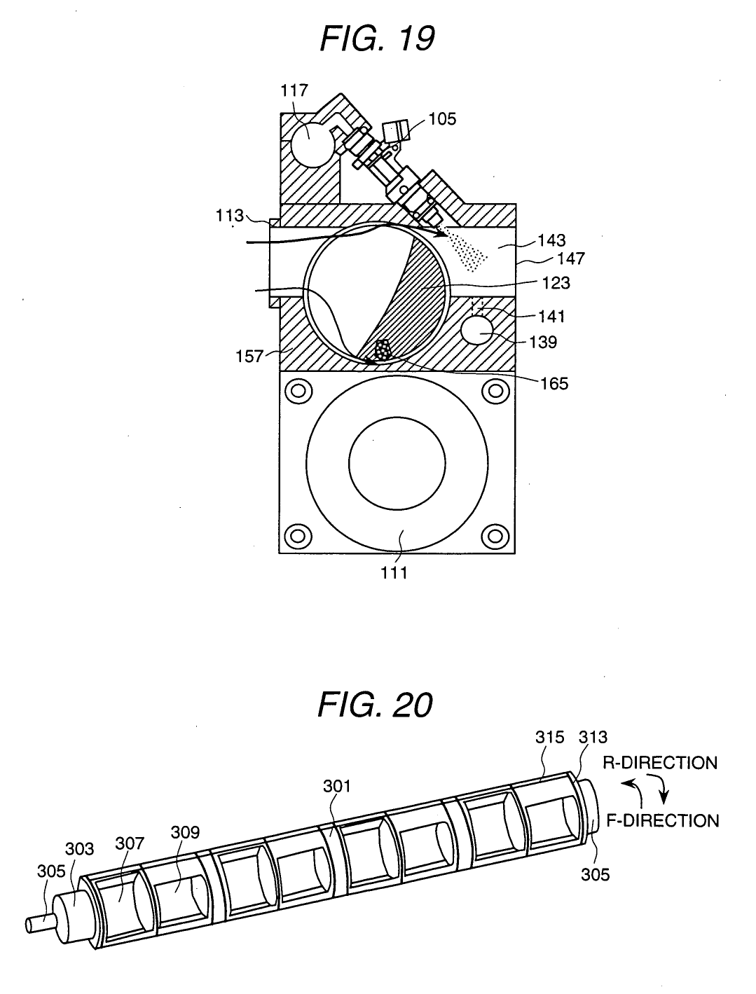

Although the air flow control valve shown in FIG. 9 is formed with a restriction at both inlet and outlet sides of the valve, a restriction may likewise be formed only at one side, as shown in FIG. 19. There is no need to allow for variations in the opening of both restrictions, and the quantity of air inlet can be stably controlled.

In the air flow control valve according to the present invention, the inlet air and mixture leakage that occurs between the inlet and outlet sides, or between adjacent inlet passageways, even when the valve is fully closed, is shut off or reduced by the following sealed structure. That is, the above-mentioned leakage is reduced by reducing, to a radial clearance of 0.2 mm or less, the clearance present between an outer surface of the air flow control valve 123, which is a rotary body, and the inner surface of the casing 157 in which the valve is enclosed, and by providing a sealing portion that excessively increases a pressure loss in comparison with the surrounding inlet passageways. Or, a structure may be adopted that assigns an integrated sealing function to a sealing mechanism 165, which becomes convex relative to other sections, by providing the air flow control valve 123 with the sealing mechanism 165 and bringing this section and the casing 157 into contact, or reducing the clearance present between both to 0.2 mm or less. By employing such a structure, a high sealing effect can be maintained without the necessity for not too significant improvement of the machining accuracy during extensive machining of the air flow control valve. The sealing portion may be formed by machining a recess in the air flow control valve itself, or by building other sealing members into the air flow control valve.

The sealed structure in an air flow control valve of the type formed with a restriction at both inlet and outlet sides in the passageway section of the valve is shown in FIG. 20. In this air flow control valve 123, guide grooves for accommodating each sealing member are machined. Arc-like inter-cylinder sealing members 313 are installed in guide grooves, each machined so as to be axially disposed across a low-flow opening 307 or a high-flow opening 309, and a movable sealing member 315 is installed in a guide groove machined longitudinally in an axial direction of the valve. The inter-cylinder sealing members 313 come into contact with surfaces of the guide grooves in the air flow control valve 123 and with an inner wall surface of a valve insertion hole 317, which contains the air flow control valve 123 in a casing 157, and leakage is reduced by blocking flow routes disposed between adjacent air inlet passageways.

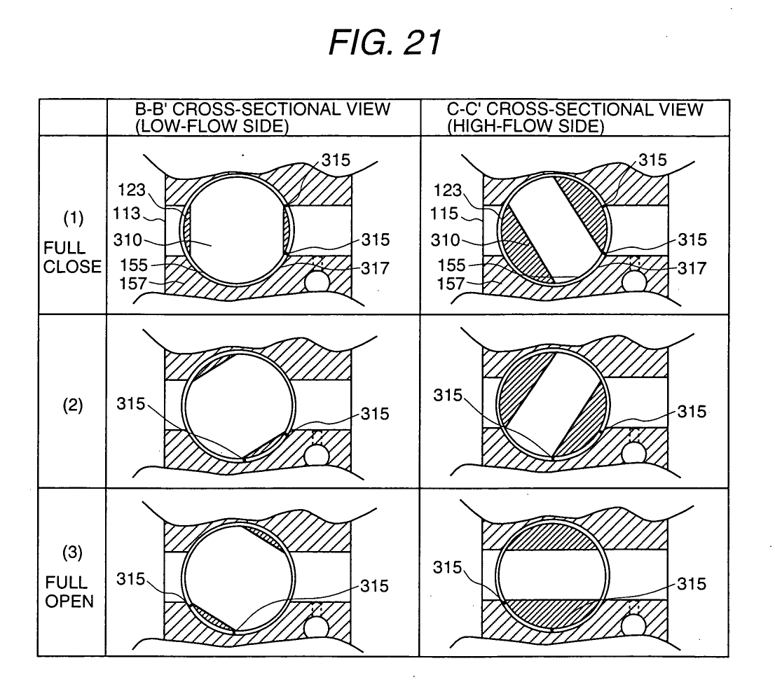

How the sealed structure works during the operation of the air flow control valve shown in FIG. 20 is illustrated in FIG. 21. As with that of FIG. 10, FIG. 21 is organized so that its left side is the upstream side, and its right side is the downstream side. The movable sealing member 315 is installed at two circumferential angles on the outer periphery of the air flow control valve. From the fully closed state shown in FIG. 21 (1), the air flow control valve 123 rotates clockwise as seen in the figure. Under the fully closed state shown in FIG. 21 (1), the inlet passageways are dimensionally minimized by the valve, and the leakage flow route where air flows from the upstream side to the downstream side appears as a clearance occurring between the air flow control valve 123 and the valve insertion hole 317. In the structure according to the present invention, this clearance is sealed as a result of the movable sealing member 315 coming into contact with the surface of the corresponding guide groove and the inner surface of the valve insertion hole, or even if no such contact occurs, it is sealed as a result of the movable sealing member 315 moving close, since it is in an extremely narrow condition, and so leakage of the air flowing through the clearance is suppressed significantly. Under the fully closed or slightly closed state of the air flow control valve, since the cross-sectional areas of the air inlet passageways are reduced significantly, a pressure difference occurs between the upstream and downstream sides of the air flow control valve. Under the rotated and opened state of the valve, as seen in FIG. 21(2) or FIG. 21(3), however, the above-mentioned pressure difference is small or becomes almost equal to zero.

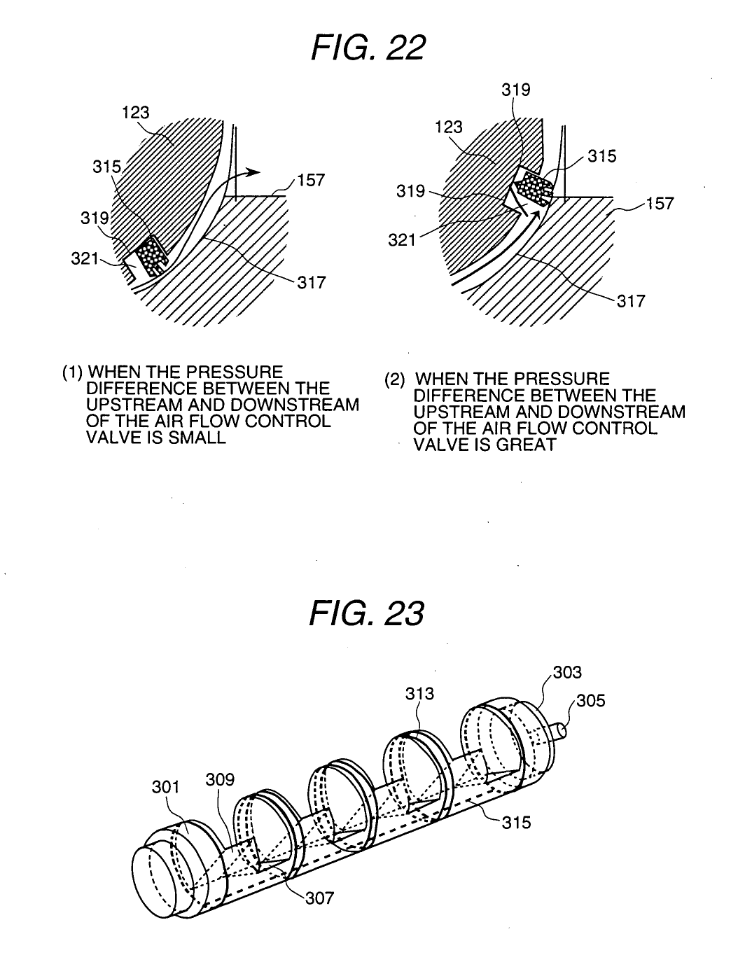

An enlarged partial cross-sectional view of the vicinity of the movable sealing member 315 in FIG. 21 is shown in FIG. 22. A guide groove 319 is machined in the air flow control valve 123, and this guide groove accommodates the movable sealing member 315 and has a holding air passageway 321. The movable sealing member 315 is movable in the range of a clearance, so-called range of play, relative to the guide groove 319. As the rotational phase of the air flow control valve 123 approaches a full closing position thereof, a significant increase in flow route resistance increases the pressure difference between the upstream and downstream sides of the air flow control valve, consequently allowing a strong air stream to flow from the high-pressure upstream side into the holding air passageway 321. The air stream applies thrust to the movable sealing member 315, which then slides in an outward direction of the air flow control valve, along the guide groove 319, which further reduces the clearance with respect to the inner surface of the valve insertion hole 317 in the casing 157. Eventually, the air stream is pressed against the inner surface of the valve insertion hole 317, thereby creating a contact sealing effect. Conversely, as the air flow control valve rotates to its opening side and the pressure difference decreases, since the holding force applied to the movable sealing member 315 is reduced significantly, this sealing member does not come into contact with the inner surface of the valve insertion hole 317, or, even if the sealing member comes into contact therewith, the contact force is very weak. The resulting sealing effect is primarily a non-contact type of gas sealing effect, so-called labyrinth effect, that enlarges or reduces the cross-sectional area in the flow route communicating with the clearance, or, more effectively, generates a pressure loss by repeating the enlarging and reducing cycles several times.

FIG. 23 shows the sealed structure in an air flow control valve of the type formed with a restriction in one place at a passageway section of the valve. This air flow control valve, as with the valve shown in FIG. 20, is applied to an in-line four-cylinder engine having two inlets per cylinder, and the air inlet for four cylinders is controlled by one such valve. Construction blocks functioning as two types of valve bodies for each air inlet passageway corresponding to one cylinder are provided, with one construction block forming a low-flow opening 307 and the other construction block forming a high-flow opening 309. Rotation of the air flow control valve 123 makes it possible to provide control to ensure that opening is started only from a left half of the air inlet passageway as seen in the figure, and that after the left half fully opens, the right half opens. It is thus possible to form a uniform flow horizontally in the air inlet passageway and to control the flow motion therein, and, furthermore, to control the flow motion in the cylinder interior functioning as the combustion chamber of the engine. In this air flow control valve, guide grooves for accommodating sealing members are also machined, inter-cylinder sealing members 313 are installed circumferentially in an axial direction of the valve, and a movable sealing member 315 is installed longitudinally in the axial direction of the valve.

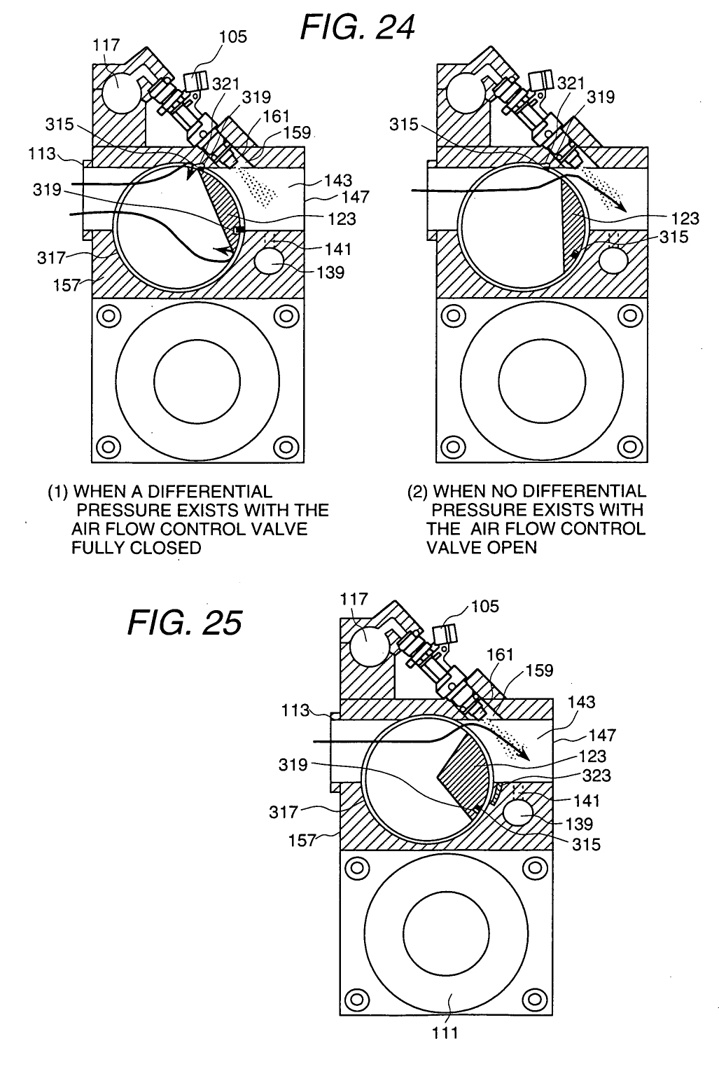

A cross section of the vicinity of the low-flow opening in the mixture supply device 101 within which the corresponding air flow control valve is stored is shown in FIG. 24. The left side in this figure is the upstream side in the direction of the air cleaner, and the right side is the downstream side in the direction of the cylinder. The movable sealing member 315 is installed at the side of the air flow control valve 123 and at the side of the valve insertion hole 317 in the casing 157. At the side of the air flow control valve 123, as described earlier, a movable sealing member 315 is accommodated in a guide groove 319. At the side of the casing 157, a holding air passageway 321 and a guide groove 319 are also machined, and a movable sealing member 315, although its shape differs from that of the one installed at the air flow control valve side, is accommodated. The movable sealing member 315 shown here is of the type having a beam-like end fixed to the side of the casing 157, so that, in the event that a pressure difference occurs, the beam-like portion deforms, thereby acting to press a sealing material of the sealing member against the outer surface of the air flow control valve 123. A similar effect is also obtainable in a structure not having a fixed portion of the beam-like portion. Under the above scheme, however, when there exists no pressure difference, the pressing force of the sealing material against the air flow control valve is reliably reduced, which yields a great suppression effect against increases in the torque required for rotational driving of the valve.

Although, in these examples, the movable sealing member is installed in two places in a circumferential direction of the rotary valve, in the event that a minimum leakage flow rate is permitted to a certain extent and more importance is to be attached to reduction in the torque required for the driving of the rotary valve, the movable sealing member may be installed in one place to obtain a balance between the sealing effect and the suppression of in the torque. Also, although the inter-cylinder sealing members 313 and the movable sealing member 315 are formed separately in the foregoing embodiment, both types of sealing members may be connected and integrally formed. Under such a scheme, although the workload required for mounting it in the air flow control valve is reduced by a decrease in the number of parts required, it is advisable in that case to make the connections easily deform so that the deformation of the movable sealing member in the vicinity of the connections moves a great majority of movable seals to make the sealing effect variable.

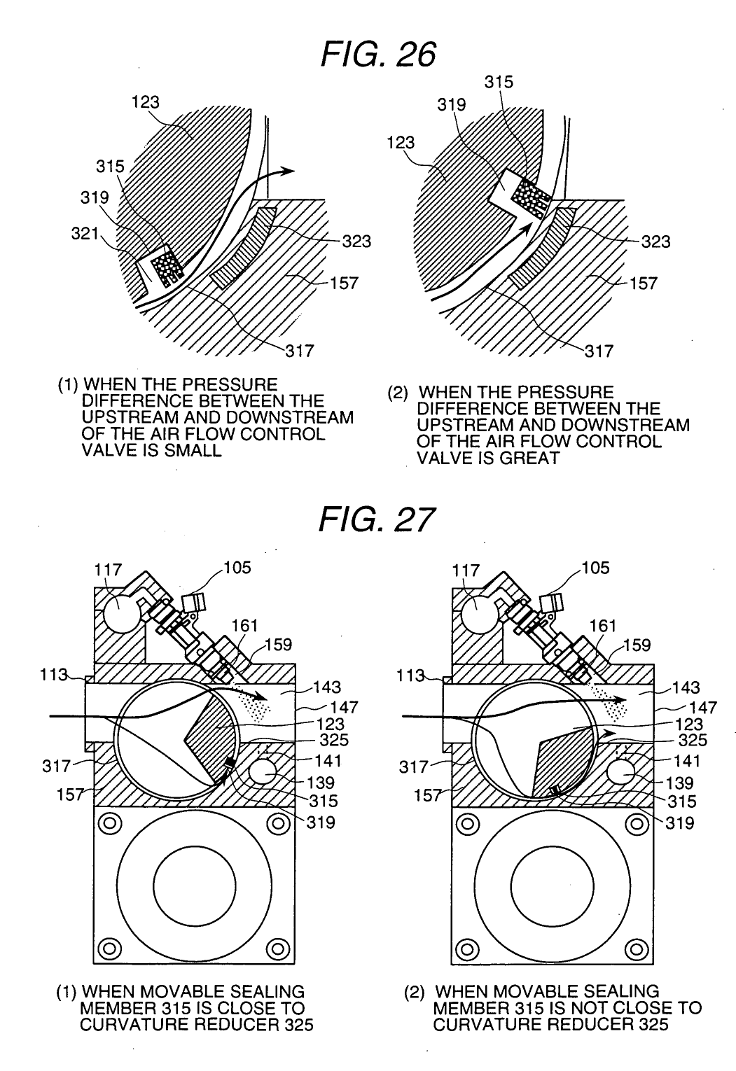

In the sealed structure cross-section shown in FIG. 25, the sealing effect is made variable using magnetic force. Referring to this figure, the movable sealing member 315 is formed of a resin material in which magnetic particles are contained. An electromagnet 323 is inserted into a seal reinforcement portion at the valve insertion hole 317 of the casing 157. The movable sealing member 315 usually has its movement gently regulated with a backlash by a guide groove 319. The operation of the movable sealing member 315 in the neighborhood of the seal reinforcement portion in FIG. 25 is shown in FIG. 26. When the movable sealing member 315 moves close to the seal reinforcement portion and a sealing effect is required, a strong magnetic field is generated by energizing the electromagnet 323, and thereby the movable sealing member 315 is attracted towards the inner surface of the valve insertion hole 317 and eventually brought into contact therewith. The movable sealing member 315, if controllable by means of the electromagnet, is capable of exhibiting a similar effect, and the magnetic material itself may be used as a sealing material, or the magnetic material may be built into a sealing material made of resin or the like. In either case, differences in machinability and weight occur, but a similar effect is obtainable. Also, the seal reinforcement portion may have an installed permanent magnet, instead of an electromagnet. In this case, there is the advantage that no electric circuitry becomes necessary.

FIG. 27 shows a structure in which, in the valve insertion hole 317 of the casing 157, a curvature reducer 325 is provided, whose section equivalent to the low-flow inlet passageway 143 or the high-flow inlet passageway 145 is smaller than other sections in terms of the curvature of a curved face, and, at the corresponding section, the distance between the air flow control valve 123 and the inner surface of the valve insertion hole 317 becomes narrower than at other sections. When rotation of the air flow control valve 123 causes the movable sealing member 315 to reach the curvature reducer 325, since the movable sealing member 315 comes into contact with the inner surface of the valve insertion hole 317 and is pushed in a central direction of the air flow control valve 123 along the guide groove 319, the clearance decreases, resulting in an increased sealing effect. Eventually, the movable sealing member 315 comes to be completely sandwiched between the air flow control valve 123 and the casing 157, thus increasing the contact force, by means of an elastic spring force, and enhancing the effectiveness of the contact sealing. Since, except at the curvature reducer 325, a movable sealing member 127 does not come into contact, or, even if contact occurs, the contact force is very weak, increases in the torque that rotates the air flow control valve 123 are suppressed.

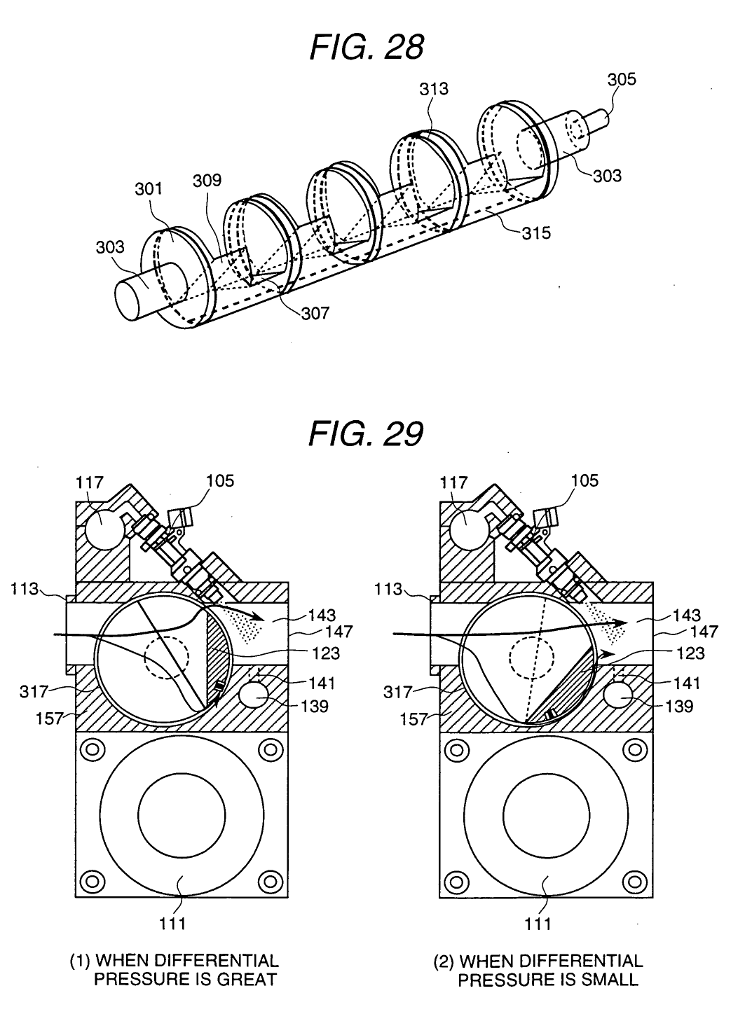

A structure in which a sealing effect of a movable sealing member 315 is made variable by utilizing a force generated when an air flow control valve 123 is deformed by the occurrence of a pressure difference between the upstream and downstream sides of the valve, is shown in FIG. 28. In this air flow control valve 123, the diameters of sections equivalent to bearing installation sections 303 at both ends are particularly small and are locally deformed. When a pressure difference occurs between the upstream and downstream sides of the air flow control valve 123, bending deformation occurs mainly at those sections. Thus, as shown in FIG. 29(1), the valve body of the air flow control valve 123 becomes proximate to an inner surface of the valve insertion hole 317 to narrow the clearance existing therebetween. In the air flow control valve 123, guide grooves 319 that accommodate sealing members are formed. Arc-like inter-cylinder sealing members 313 are inserted circumferentially in an axial direction of the valve, and a movable sealing member 315 is inserted longitudinally in the axial direction of the valve. When there is no pressure difference, as shown in FIG. 29(2), the movable sealing member 315 creates a non-contact sealing effect that narrows the cross-sectional area of the flow route. As a pressure difference occurs and increases, however, the movable sealing member 315 is, as shown in FIG. 29(1), pushed towards the valve insertion hole 317 by a displacement of the air flow control valve 123, and eventually it comes into contact to physically block the flow route and thus to generate a contact sealing effect.

In these embodiments, the sealed structure may likewise be formed at the casing side on the basis of a similar concept. By doing so, a stable sealing effect is obtainable, even if the rotating range of the air flow control valve is extended.

It is also possible to prevent the entire valve from clogging with any entrapped foreign substances by making the sealed structure easily deformable and movable as described in connection with these embodiments.

The materials of the inter-cylinder sealing members 313 and movable sealing member 315 in these embodiments are selected from the group consisting of metals, resin, rubber, ceramics, or the like. To reduce the load torque, it is effective to use resin materials that have excellent lubrication characteristics, such as fluorinated resin, polyether-ether-ketone (PEEK) resin, polyimide resin, polyamide resin, or polyphenylene sulfide (PPS) resin.

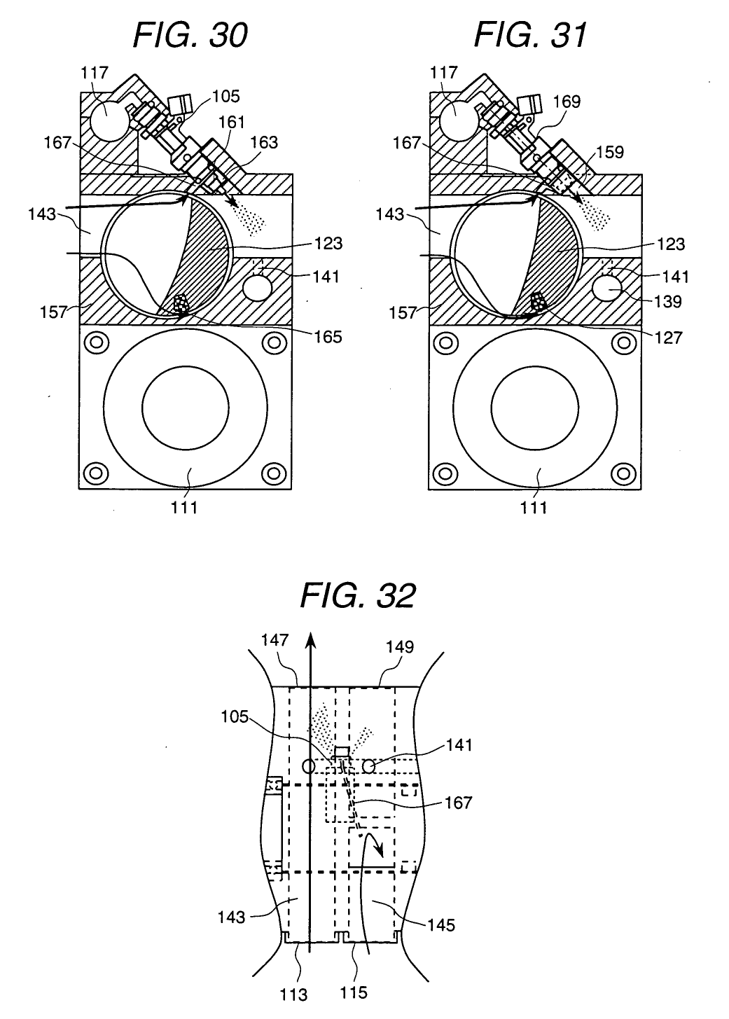

Inside the mixture supply device, fuel particles are atomized, as shown in FIG. 4, by inducting an air stream into the main body or fuel spraying port of the fuel spraying mechanism 105 by means of an air flow control valve 123 installed in proximity to the fuel spraying mechanism, and then bringing the air stream and the fuel particles into a collision state. In particular, the atomizing effect of fuel particles can be enhanced, as shown in FIGS. 17 (2) and 18, by supplying an air stream in deflected form to the fuel spraying port and making a high-speed air stream collide concentratedly with fuel immediately after it is emitted from the spraying port. Or, as shown in FIG. 30, an air-assist-type mount 163 is formed in the casing 157 of the multiple-throttle mechanism, and an air stream is inducted into the mount through an assist air supply passageway 167. The air-assist-type mount 163 is formed so that a clearance created between a fuel spraying port 161 of the fuel spraying mechanism 105, at which the mount is to be installed, and a bottom of the mount is narrowed to less than 2 mm to allow an air stream to collide, almost perpendicularly relative to the fuel spraying direction, with fuel immediately after it is emitted from the spraying port, and the collision further atomizes the fuel. The use of this method makes it possible to obtain fine-droplet fuel particles effectively, even if the fuel spraying mechanism 105 itself does not have a special atomizing structure, and to construct the fuel spraying mechanism less expensively. Accordingly, even when the fuel spraying mechanism requires replacement associated with an extended period of use, the replacement expenses can be reduced. Or, as shown in FIG. 31, in a mount 159 machined in the casing 157 of the multiple-throttle mechanism, an air-assist-type fuel spraying device 169 is provided, which has a mechanism that is supplied with air from the outside and of atomizing fuel particles emitted from the air-assist-type fuel spraying device itself, and the air stream is supplied thereto through the assist air supply passageway 167. The use of this method also allows an atomizing effect to be obtained. In this method, the accuracy in the machining of the casing and in the assembly of the mixture supply device is not affected significantly, and this allows stable atomization of fuel. The position in which the assist air supply passageway 167 in the structure shown in FIG. 30 or FIG. 31 communicates with an inlet passageway to take in an air stream is provided either at the same position as that of the air flow control valve or at an upstream side thereof, and the air stream is taken in by utilizing the pressure difference with respect to a downstream side of the air flow control valve. In FIG. 30 or FIG. 31, an inlet of the assist air supply passageway 167 is provided at a position where the air stream concentrates along the profile of the valve under its slightly open state in order for pressure to increase above an ambient pressure. In such a structure, a greater atomizing effect can be obtained by supplying a higher-speed air stream under a slightly open state, in particular. Also, in the event that, as seen in FIGS. 10(1) to 10(3), a mixture is usually to be formed by opening only the restriction in the low-flow inlet passageway, the inlet port of the assist air supply passageway 167 is provided in the high-flow inlet passageway, as shown in FIG. 32. Although the pressure at the low-flow side is reduced by the opening of its restriction, a more stable fuel-atomizing effect can be obtained under a slightly open state by supplying an air stream at high pressure from the high-flow side, whose restriction does not open.

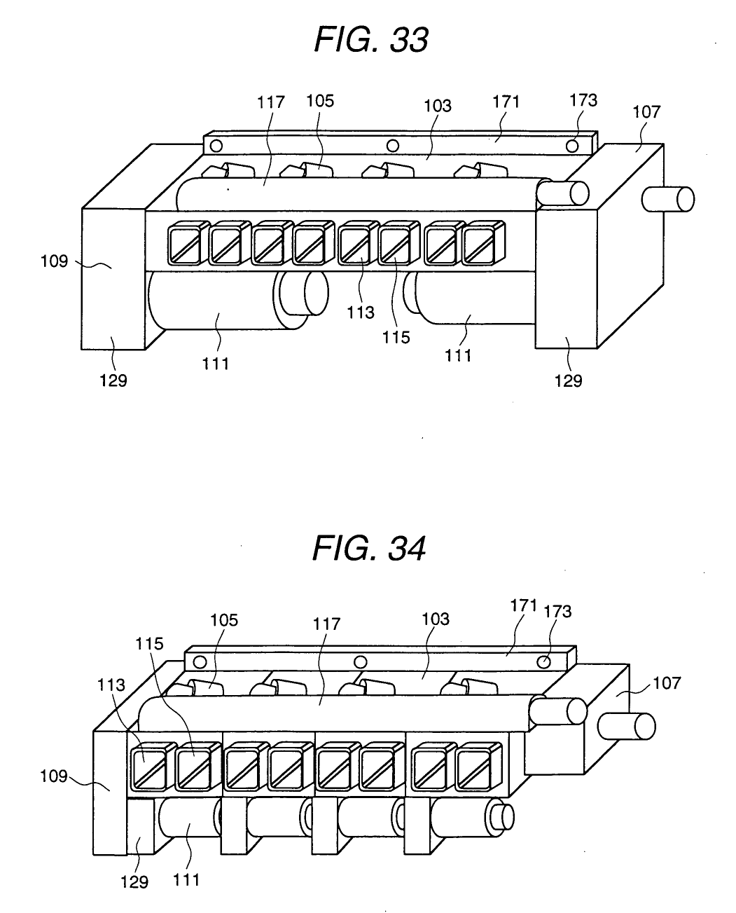

Under the embodiment shown in FIG. 1, in the multiple-throttle mechanism 103 of the mixture supply device 101 directed for use in an in-line four-cylinder automobile engine having two inlets per cylinder, the air flow control valve 123 that integrally controls four cylinders of inlet air is driven by one motor 111. This scheme has the advantage that, since only one motor is used for air flow control, inexpensive manufacture of the device is possible. Or, as shown in FIG. 33, it may be possible to adopt a type in which there are two sets comprising air flow control valves, motors, and drives corresponding to air inlet for two cylinders. In this case, compared with the structure shown in FIG. 1, since the air flow control valve dimensions per motor can be reduced, it is possible to obtain such features as minimizing the driving force required of the driving motors, increasing the responsiveness of the valve driving, minimizing any effects of thermal deformation in an axial direction of the valve, and improving the accuracy of control of the air streams. Furthermore, any air inlet variations per cylinder that occur for various reasons, such as the possible nonuniformity of valve machining accuracy or deposition of foreign substances, are easily correctible by providing correspondingly the number of throttle position sensors required. Variations in air inlet per cylinder are derived by measuring the pressures at the upstream and downstream sides of the air flow control valve by use of pressure sensors or measuring the differential pressure between both sides and then calculating, at the integrated controller, the flow rate of air from the relationship with the opening size of the restriction according to the valve position, or by taking into the integrated controller the output from either a sensor for detecting the oxygen concentration in after-combustion exhaust, or an air-fuel ratio sensor for measuring the ratio between air and fuel, and then estimating actual variations in air inlet for each cylinder. Or, a structure as shown in FIG. 34 may be usable, which has four built-in sets each comprising an air flow control valve, motor, drive, and throttle position sensor corresponding to each cylinder. It is possible under this scheme to determine the quantity of mixture to be supplied for each cylinder and to control a fine-droplet mixture flow rate that is reduced in fluctuations. Furthermore, it may be possible to connect four units, on each of which a fuel spraying mechanism, a throttle mechanism casing, an air flow control valve, a throttle position sensor, and a motor are constructed for one cylinder, and, finally, to construct one mixture supply device. This construction method makes it possible to assemble the mixture supply device in response to different inter-cylinder distances and thereby to apply the mixture supply device easily to a number of types of engines.

As set forth above, according to the preferred embodiments of the present invention, the following mixture supply device is constructed.

A mixture supply device, to be used in a multi-cylinder internal-combustion engine for automobiles, is of the type in which, in a multiple-throttle mechanism is assembled having an air flow control valve formed with one or more restrictions in each of inlet passageways connected to respective cylinders, and in which the shapes of the restrictions are varied by rotating the air flow control valve by means a motor. Motor-driven fuel spraying mechanisms are provided each corresponding to one cylinder; a motor-driven exhaust recirculating mechanism is provided for collecting part of the exhaust generated by combustion of a mixture in the above-mentioned internal-combustion engine and then remixing the exhaust into the above-mentioned mixture; and an integrated controller is provided for simultaneously exchanging control signals with the above-mentioned three types of mechanisms.

The foregoing mixture supply device is constructed such that the air flow control valve contained in the multiple-throttle mechanism is capable of being independently provided with a restriction in a plurality of inlet passageways, of being provided with restrictions of different shapes for each inlet passageway, even at the same rotational angle, thereby controlling the quantity and velocity of mixture discharged into the inlet passageway, and of changing the direction of an air stream after its passage through a restriction, to the original inlet direction, thus controlling the swirl motion and other flow motions of the air in the mixture flowing inside the inlet passageway.

The foregoing mixture supply device is controlled such that the fuel spraying mechanisms are disposed so as to correspond to respective cylinders, with spraying ports of these fuel spraying mechanisms being positioned downstream with respect to the air flow control valve, closer to the cylinders, in the inlet passageways, for spraying fuel towards the inside of each inlet passageway.

The foregoing mixture supply device is constructed such that, by use of the air flow control valve contained in the multiple-throttle mechanism, an air stream faster than an average air velocity in the inlet passageway can be supplied to the inside of the fuel spraying mechanism or to the vicinity of its spraying port and the fast air stream can be made to collide with a fuel immediately after its exit from the internal spraying port of the fuel spraying mechanism.

The foregoing mixture supply device is constructed such that a recirculated-exhaust distribution passageway for distributing to each inlet passageway the exhaust previously controlled by the above-mentioned exhaust recirculating mechanism is built into the multiple-throttle mechanism, and wherein a recirculated-exhaust entry port communicating with each inlet passageway, from the recirculated-exhaust distribution passageway, is opened both at a downstream side facing the cylinder, with respect to the air flow control valve, in the inlet passageway, and at a location other than a position in a circumferential direction of the inlet passageway where the fuel spraying port of the fuel spraying mechanism exists.

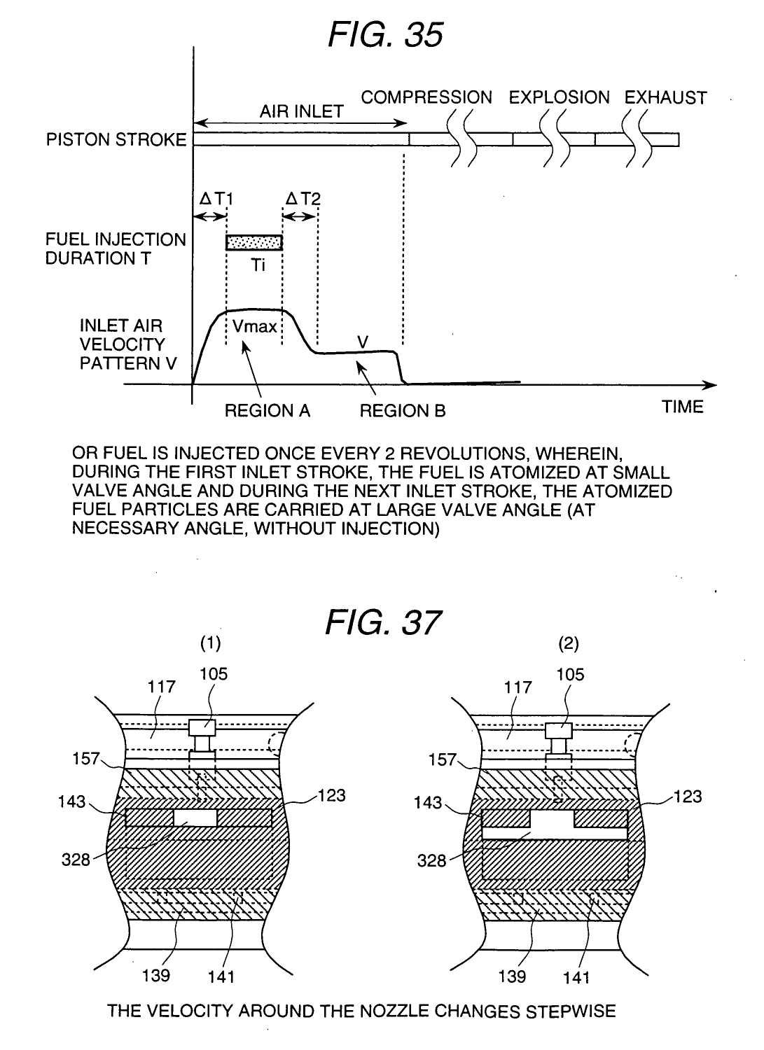

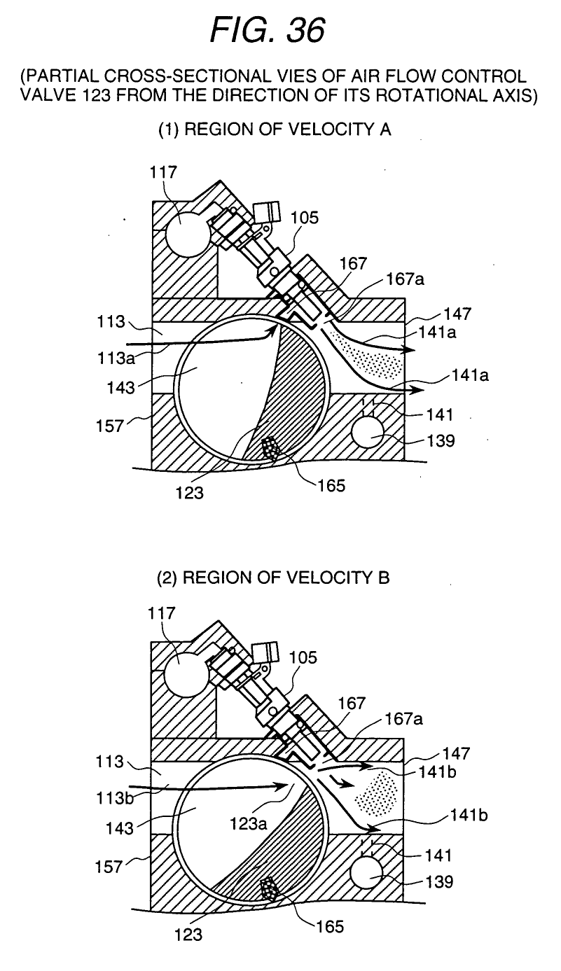

FIGS. 35 to 40 show embodiments pertaining to the formation of a mixture during engine start using the mixture supply device of the present invention. The rotating state of the air flow control valve 123 and a method of setting the injection timing of the fuel spraying mechanism 105 are described below with reference to FIGS. 35 and 36.

Piston strokes, a fuel injection duration T, and an inlet air velocity pattern V are shown in FIG. 35. Fuel injection (pulse width: Ti) is set with a delay time of ΔT1 assigned initially during the air inlet stroke interval of the engine. The inlet air velocity is controlled so that in response to the thus-set injection timing, the velocity reaches a maximum velocity of Vmax (region A) during the injection pulse width of Ti, and then, after the end of the injection pulse, it is changed to a desired velocity of V (region B) with a delay time of ΔT2.

FIG. 36 shows the operating state of the air flow control valve 123 that correspond to the above-described velocity pattern. FIG. 36(1) shows velocity region A, wherein an air stream 113a flows through an assist air supply passageway 167 communicating with the opening in the air flow control valve 123, then passes around a nozzle injection hole in the fuel spraying mechanism 105, and discharges from an opening 167a in the supply passageway. In this opening 167a, the air stream collides with fuel particles, so that atomization thereof is accelerated. Also, downstream from the opening 167a, an air stream 141a flows in such a manner that it encompasses the atomized fuel particles to suppress their sticking to a wall surface of the passageway. FIG. 36(2) shows velocity region B, wherein the air flow control valve 123 has its opening 123a further spread, an air stream 113b flowing in from the opening 123a flows to the downstream of the opening 167a in the assist air supply passageway 167, and an air stream 141b pushes injected fuel particles from the rear and carries the particles in an encompassing form.

Although a rotary valve is used as the air flow control valve 123, in comparison with two inlet passageways limited to the use of a butterfly valve, there are a number of advantages, such as local obtainability of high-speed air streams and high flexibility of the openings in shape. Also, since the fuel spraying port of the fuel spraying mechanism 105 is provided downstream from the air flow control valve 123, it is possible to avoid the sticking of sprayed fuel to a sliding surface and other sections of the air flow control valve 123. Hereby, it is possible to prevent the air flow control valve 123 from malfunctioning due to the presence of solid deposits.

Although the inlet air velocity pattern shown in FIG. 35 is controlled in a step-by-step fashion, in the case of one fuel injection cycle for two air inlet cycles, sprayed fuel particles may likewise be carried, during the first inlet cycle, by atomizing the fuel particles under a slightly open status (fixed), and then, during the next inlet cycle, injecting no fuel under a significantly open state (fixed).

FIG. 37 shows the relationship in position between the opening shape of the inlet passageway and the fuel spraying mechanism 105. FIG. 37(1) shows an opening state 328 under which the velocity around the fuel spraying mechanism 105 is increased by restricting the opening area of the inlet passageway, whereas FIG. 37(2) shows a convex-shaped opening state 331 under which, from the above state, the quantity of air is increased by spreading the opening area in a step-like fashion. Such a velocity pattern as shown in FIG. 35 is obtained by controlling the thus-machined opening in the air flow control valve 123.

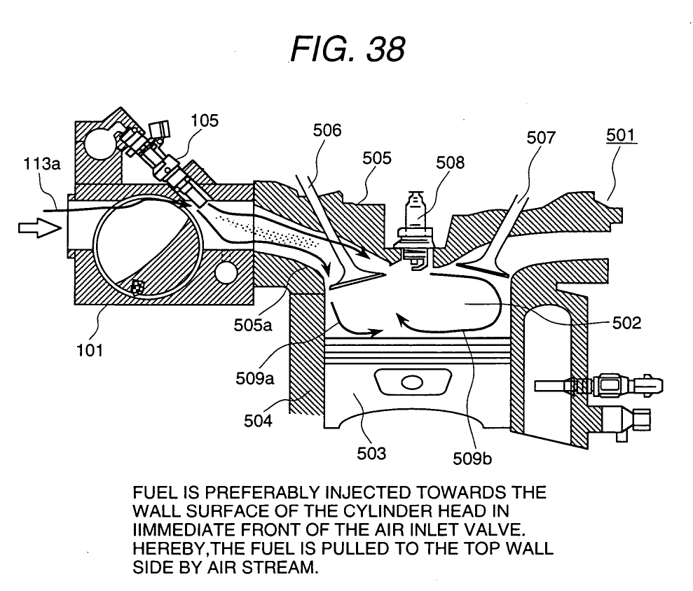

FIGS. 38 to 40 show engine-test-based confirmation results on usage effectiveness of the mixture supply device in connection with the formation of a mixture during engine start.

FIG. 38 shows one of the cylinders 501 in a multi-cylinder internal-combustion engine, wherein the mixture supply device 101 of the present invention is provided near an air inlet valve 506. Numerals 502, 503, 504, 505, and 506 denote a combustion chamber, a piston, a cylinder, a cylinder head, and an air inlet valve for opening and closing an air inlet, respectively. Similarly, numerals 507 and 508 denote an exhaust valve and an ignition plug, respectively.

Tests were conducted to monitor the quantity of hydrocarbon (HC) emitted during a change from the 200-rpm operating state of the engine, called “cranking”, immediately after the engine of the automobile was started by turning the key to its ON position, to 1,400-rpm operation, called “first idling”. Attention was paid particularly to a time of about 20 seconds from the start. The engine coolant temperature at this time was 25° C. Also, the injection pulse width Ti of the fuel spraying mechanism 105 was about 7 milliseconds.

An air stream 113a flowing in from the mixture supply device 101 is carried so that the fuel particles injected from the fuel spraying mechanism 105 during an air inlet stroke of the internal-combustion engine do not stick to a wall surface 505a of the cylinder head 505. The air stream is thus carried because the injection direction of the fuel spraying mechanism 105 is set to the direction of the wall surface 505a of the cylinder head and because air streams 509a and 509b flow along an inner wall surface of the cylinder 504. Provided that, during the start of the internal-combustion engine, the flow of a fuel can be prevented from stopping and staying inside the inlet passageway for reasons such as sticking to a wall surface, it is possible to rapidly induct injected fuel into the combustion chamber and thus to shorten the time required for the ratio between the air and fuel (air-fuel ratio) within the combustion chamber to reach a combustible level. It is therefore possible to reduce the time required for engine start (in other words, to improve startability) and also to reduce the quantity of fuel discharged during the period from the complete explosion stroke of the engine to the start thereof. Furthermore, if the stoppage of the fuel is cleared, this is also effective for accelerating a transient response during which the output of the engine changes. If the quantity of air changes according to the particular load of the engine, the quantity of fuel injection also needs to be changed to maintain the internal air-fuel ratio of the combustion chamber at the required value. At this time, if fuel remains in the air inlet pipe, the possible inflow of the remaining fuel into the combustion mixture may cause a mixture that is denser than the required value in terms of air-fuel ratio to flow into the combustion chamber; or, during the air inlet stroke of the engine, since injected fuel does not flow into the combustion chamber and all the fuel stays therein, a fuel denser or thinner than the required value in terms of air-fuel ratio may flow into the combustion chamber. Therefore, if a fuel denser or thinner than the required value in terms of air-fuel ratio flows into the combustion chamber, the engine may not exhibit its required performance. If such remaining state of fuel is cleared, the response time up to the arrival of the air-fuel ratio within the combustion chamber at the required value is reduced, even in the event of a change in engine output, and, consequently, the above problem is avoidable.

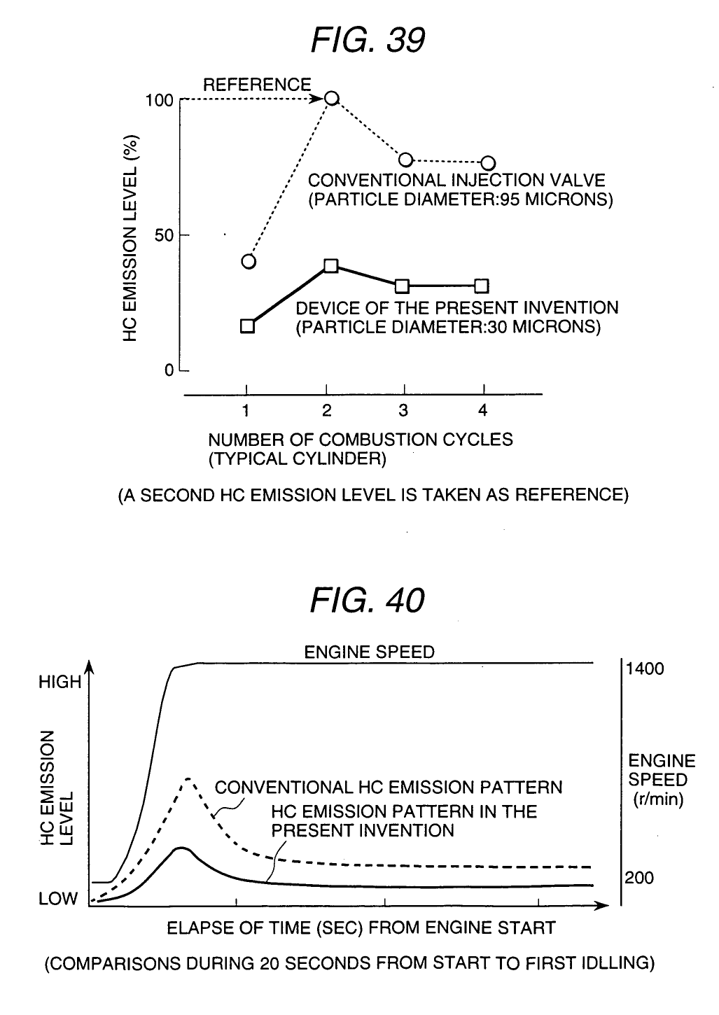

FIG. 39 shows HC emission levels relative to the number of combustion cycles within a typical cylinder. When a conventional fuel injection device (95 microns in fuel particle size) was used in such a conventional air inlet system as shown in FIG. 5, the greatest quantity of HC was emitted during the second combustion cycle from engine start. This is caused mainly by the fact that, as described above, since the large particle size of fuel during its first injection cycle at the start of the engine makes the fuel prone to stick to the wall surfaces of the inlet passageway or of the combustion chamber, the fuel which remains as a wall stream after not being used during the first combustion cycle is added during the second combustion cycle. In the figure, the HC emission level measured after the second combustion cycle from when engine start occurred is taken as a reference level, and the values measured after the first, third, and fourth combustion cycles have occurred are reduced and arranged for comparison. After the third and fourth combustion cycles, since the air velocity gradually increases, the combustion progresses (the wall stream is suppressed) and this slightly reduces the respective HC emission levels.

In the mixture supply device 101, however, since the particle size of sprayed fuel is sufficiently small (30 microns or less), the acceleration of its gasification rapidly progresses the combustion and the air velocity is also increased during the second combustion cycle onward, with the result that the combustion is further accelerated and there occur no increases in HC emission level.

In FIG. 40, an HC emission pattern obtained during about 20 seconds from engine start to first idling is shown for comparison with the pattern in the case of an engine which uses a fuel injection device of 95 microns in particle size in the configuration of FIG. 5. The HC emission levels here are reduced to almost half of the conventional levels. This is due to the fact that accelerated atomization of the fuel has accelerated its gasification and improved the gasification rate of the fuel flowing into the combustion chamber. These results indicate that a decrease in the quantity of liquid fuel flowing into the combustion chamber has reduced the quantity of unburnt fuel components within the exhaust and also improved the startability.

Another favorable effect is characterized in that, since no equipment is required by which the air for atomization is to be supplied to the fuel spraying mechanism separately, the atomization of fuel can be accelerated without any increases in costs. In addition, since the mixture supply device is provided for each cylinder, the quantity of mixture flowing into each cylinder is adjustable and the quantity of fuel is also adjustable for each cylinder. Accordingly, it is possible to suppress variations in the air-fuel ratio for each cylinder and variations in the inflow rate of the mixture and thus to operate the internal-combustion engine stably and suppress the occurrence of vibration and other unusual events due to abnormal combustion or the like.

<Effects of the Invention>

As described above, with use of the mixture supply device of the present invention, a mixture of air, fuel and recirculated exhaust, which have their flow rates and fluidity controlled near the cylinders of an engine, can be supplied with high responsiveness relative to the output command sent by a driver to the engine. In particular, during the start of the engine, during low-speed operation thereof, and at low flow rates of air, by increasing the velocity of the air and improving the air inlet efficiency of the cylinders, or by atomizing the fuel and supplying a mixture that is high in air fluidity, the combustion state of the mixture can be improved to achieve reduced harmful exhaust gas emissions from the engine and reduced fuel consumption.

It is also possible to provide a mixture supply device that supplies a mixture desirable for the startability and responsiveness of an internal-combustion engine.

What is claimed is:

1. A mixture supply device for use in a multi-cylinder type of internal-combustion engine, installed on an air inlet pipe adapted to diverge and then re-converge inlet passageway sections connected to respective cylinders; said mixture supply device comprising:
a first construction block in which a rotary body, a passageway section formed inside said rotary body, and an opening formed on part of an outer periphery of said rotary body are constructed, and
a second construction block in which a passageway section formed inside said rotary body and an opening formed on part of the outer periphery of said rotary body are constructed;
and wherein:
there is formed an air flow control valve provided with a rotating device for rotating said rotary body in a reversibly bi-directional manner, said air flow control valve being further formed with a restricting portion at which restrictions in said two construction blocks each change in shape according to a particular rotary motion of said rotary body;
there is constructed a multiple-throttle mechanism that contains said air flow control valve inside; and
there is provided a fuel spraying device having a fuel spraying port disposed in proximity to the restricting portion in said air flow control valve.

2. A mixture supply device for use in a multi-cylinder type of internal-combustion engine, installed on an air inlet pipe adapted to diverge and then re-converge air inlet passageway sections connected to respective cylinders; said mixture supply device comprising:
a first construction block in which a rotary body, a passageway section formed inside said rotary body, and an opening formed on part of an outer periphery of said rotary body are constructed, and
a second construction block in which a passageway section formed inside said rotary body and an opening formed on part of the outer periphery of said rotary body are constructed;
and wherein:
there is formed an air flow control valve provided with a restricting portion at which restrictions in said two construction blocks change in shape so as to differ from each other according to a particular rotary motion of said rotary body;
there is constructed a multiple-throttle mechanism that contains said air flow control valve inside; and
there is provided a fuel spraying device having a fuel spraying port disposed in proximity to the restricting portion in said air flow control valve.

3. A mixture supply device for use in a multi-cylinder type of internal-combustion engine, installed on an air inlet pipe adapted to diverge and then re-converge air inlet passageway sections connected to respective cylinders; said mixture supply device comprising:
a first construction block in which a rotary body, a passageway section formed inside said rotary body, and an opening formed on part of an outer periphery of said rotary body are constructed, and
a second construction block in which a passageway section formed inside said rotary body and an opening formed on part of the outer periphery of said rotary body are constructed;
and wherein:
there is formed an air flow control valve provided with a restricting portion at which restrictions in said two construction blocks change in shape so as to differ from each other according to a particular rotary motion of said rotary body;
there is constructed a multiple-throttle mechanism that contains said air flow control valve inside;
there is provided a fuel spraying device having a fuel spraying port disposed in proximity to the restricting portion in said air flow control valve; and
a recirculated-exhaust entry port is disposed in proximity to the restricting portion in said air flow control valve, and an exhaust recirculating mechanism is provided, so that controlled inlet air, sprayed fuel particles, and recirculated exhaust are mixed near a downstream side of the restricting portion.

4. The mixture supply device for an internal-combustion engine, defined in any one of claims 1 to 3; wherein two restrictions are constructed in a rotational direction of said air flow control valve.

5. The mixture supply device for an internal-combustion engine, defined in any one of claims 1 to 3; wherein, for one restriction in said air flow control valve, a rotational angle of said rotary body is set to ensure that an outlet direction of inlet air faces the vicinity of said fuel spraying port and that a high-speed air stream is supplied to the vicinity of said fuel spraying port and then made to collide with a fuel injection stream sprayed therefrom.

6. The mixture supply device for an internal-combustion engine, defined in any one of claims 1 to 3; wherein the opening in the first construction block and the opening in the second construction block are formed with different sizes, both openings being disposed so as to differ in a direction of opening.

7. The mixture supply device for an internal-combustion engine, defined in any one of claims 1 to 3; wherein said air flow control valve has parallel guide grooves, one in an axially circumferential direction of a rotational axis of said valve and the other in a longitudinal direction, the axially circumferential guide groove being formed with arc-like sealing members communicating between adjacent inlet passageways in order to block flow routes for the air moving therethrough, and the longitudinal guide groove being formed with bar-like movable sealing members to block flow routes for the air leaking from an upstream side of said valve to a downstream side thereof under a fully closed valve state.

8. The mixture supply device for an internal-combustion engine, defined in any one of claims 1 to 3; wherein said air flow control valve has parallel guide grooves in an axially circumferential direction of a rotational axis of said control valve, said flow control valve further containing, therein, movable sealing members each capable of moving inside a guide groove in order to reduce the flow rate of the air leaking from an upstream side of said valve to a downstream side thereof; and wherein each movable sealing member is pressed in a reducing direction of an air flow route clearance by an air pressure difference occurring between the upstream and downstream of said control valve, depending on whether said control valve is fully closed or remains almost closed, and the movable sealing member thereby comes into contact with a mating surface to create a contact sealing effect for blocking the air flow route clearance, and when said air pressure difference is small, yields a variable sealing effect so as to mainly produce a non-contact sealing effect.

9. The mixture supply device for an internal-combustion engine, defined in any one of claims 1 to 3; wherein said air flow control valve has a deformed section whose cross-sectional area is particularly small; and wherein, depending on an air pressure difference occurring between an upstream and downstream of said control valve under a fully closed or almost closed valve state, a body of said valve, or particularly, its deformed section is deformed and hereby a sealing section provided in said valve is pressed in a reducing direction of an air flow route clearance, with the result that the sealing section thereby comes into contact with a mating surface to create a contact sealing effect for blocking the air flow route clearance around said valve, and when said air pressure difference is small, yields a variable sealing effect so as to mainly produce a non-contact sealing effect.

10. The mixture supply device for an internal-combustion engine, defined in any one of claims 1 to 3; wherein said arc-like sealing members and said movable sealing members installed in said air flow control valve are constructed of fluorinated resin, polyether-ether-ketone resin, polyimide resin, polyamide resin, polyphenylene sulfide resin, and a resin material formed mainly from these substances.

11. A mixture supply device for use in a multi-cylinder type of internal-combustion engine, having an air flow control valve for adjusting the quantity of air taken in;
wherein:
inside an inlet passageway hole communicating with an opening in a restricting portion of said air flow control valve, a fuel spraying port of a fuel spraying mechanism is disposed downstream relative to the opening in said restricting portion; and
a high-speed air stream created by said restricting portion during starting operation of the internal-combustion engine is inducted from an outer periphery of said fuel spraying mechanism to said fuel spraying port and atomizes and carries fuel particles injected.

12. A mixture supply device for use in a multi-cylinder type of internal-combustion engine, having an air flow control valve for adjusting the quantity of air taken in, with said air flow control valve being changed in terms of cross-sectional shape of an opening in a restricting portion by a rotary motion;
wherein:
inside an air inlet passageway hole communicating with said opening, a fuel spraying port of a fuel spraying mechanism is disposed downstream relative to said opening in said restricting portion; and
during an air inlet stroke duration at the start of operation of the internal-combustion engine, an opening area of said restricting portion is controlled so as to increase, and a high-speed air stream created by said restricting portion is inducted from an outer periphery of said fuel spraying mechanism to said fuel spraying port, atomizes fuel particles injected, and carries the atomized fuel particles by means of a quantitatively increased air stream.

13. A mixture supply device for use in a multi-cylinder type of internal-combustion engine, having an air flow control valve for adjusting the quantity of air taken in, with said air flow control valve adjusting the quantity of air by being changed in cross-sectional shapes of openings in restricting portions by a rotary motion;
wherein:
said openings are of a convex shape, with the opening at a smaller-area side being disposed so as to be positioned inside an air inlet passageway hole in which is contained a fuel spraying port of a fuel spraying mechanism, and the opening at a larger-area side, positioned outside the air inlet passageway hole; and
during an air inlet stroke duration at the start of operation of the internal-combustion engine, control is provided in order for the smaller-area opening to be changed to the larger-area opening, and a high-speed air stream created by said corresponding restricting portion is inducted from an outer periphery of said fuel spraying mechanism to said fuel spraying port, atomizes fuel particles injected, and carries the atomized fuel particles by means of a quantitatively increased air stream.
